(19) United States
(12) Patent Application Publication
(10) Pub. No.: US 2025/0385764 A1
(43) Pub. Date: Dec. 18, 2025

(54) APPARATUSES, METHODS, AND COMPUTER PROGRAMS FOR ADAPTIVE FDSS FILTERING

(71) Applicant: Nokia Technologies Oy, Espoo (FI)

(72) Inventors: Sajad REZAIE, Aalborg (DK); Oana-Elena BARBU, Aalborg (DK); Christian ROM, Aalborg (DK)

(21) Appl. No.: 19/233,509

(22) Filed: Jun. 10, 2025

(30) Foreign Application Priority Data
Jun. 14, 2024 (GB) 2408537.5

(51) Int. Cl. H04L 5/00; H04L 25/03

(52) U.S. Cl. CPC H04L 5/001; H04L 25/03853

(57) ABSTRACT

An apparatus (10, 110) comprising: means for transmitting, to a second apparatus (120), first information (1901) indicative of a capability of the apparatus to adapt at least one of: a frequency-domain spectral shaping (1902), FDSS, filter for FDSS-based orthogonal frequency division multiplexing, OFDM, transmission, or a spectral extension parameter (1903) for use in FDSS-based OFDM with spectral extension transmission; means for receiving, from the second apparatus based at least in part on the transmitted first information, second information (1904), wherein the second information comprises information for configuring the apparatus to adapt at least one of the FDSS filter (1905) or the spectral extension parameter (1906); means for determining an adaptation to apply to at least one of the FDSS filter or the spectral extension parameter, wherein the determination is based at least in part on the received second information, and wherein the adaptation comprises adapting at least one of: at least one of a plurality of filter coefficients (1909) of the FDSS filter, at least one of one or more filter parameters (1910), or the spectral extension parameter (1903, 1911); and means for transmitting, to the second apparatus, at least one FDSS-based OFDM transmission (1914), wherein the transmitting uses at least one of: the FDSS filter with the determined adaptation applied thereto, or the spectral extension parameter with the determined adaptation applied thereto.

### TECHNOLOGICAL FIELD

Examples of the disclosure relate to apparatuses, methods, and computer programs for adaptable frequency-domain spectral shaping, FDSS, filters (i.e. FDSS filters whose design/configuration can be adapted, not least such as machine learning, ML, based FDSS filters of deep transceivers) for FDSS-based orthogonal frequency division multiplexing, OFDM, transmission (e.g. FDSS-based discrete Fourier transform spread, DFT-s, OFDM transmission).

### BACKGROUND

Conventional signaling frameworks for supporting FDSS filters are not always optimal. In some circumstances, it may be desirable to provide improved signaling frameworks for supporting FDSS filters. In some circumstances, it may be desirable to provide improved signaling frameworks for supporting adaptable FDSS filters.

In some circumstances, it may be desirable to provide improved signaling frameworks for supporting inference using adaptable FDSS filters to provide adaptive FDSS filtering.

### BRIEF SUMMARY

The invention is defined in the independent claims.

According to various, but not necessarily all, examples of the disclosure there are provided examples as claimed in the appended claims. Any examples and features described in this specification that do not fall under the scope of the independent claims are to be interpreted as examples useful for understanding various embodiments of the invention.

According to at least some examples of the disclosure there is provided an apparatus comprising:
means for transmitting, to a second apparatus, first information indicative of a capability of the apparatus to adapt at least one of:
   a frequency-domain spectral shaping, FDSS, filter for FDSS-based orthogonal frequency division multiplexing, OFDM, transmission, or
   a spectral extension parameter for use in FDSS-based OFDM with spectral extension transmission;
means for receiving, from the second apparatus based at least in part on the transmitted first information, second information, wherein the second information comprises information for configuring the apparatus to adapt at least one of the FDSS filter or the spectral extension parameter;
means for determining an adaptation to apply to at least one of the FDSS filter or the spectral extension parameter, wherein the determination is based at least in part on the received second information, and wherein the adaptation comprises adapting at least one of:
   at least one of a plurality of filter coefficients of the FDSS filter,
   at least one of one or more filter parameters, or
   the spectral extension parameter; and
means for transmitting, to the second apparatus, at least one FDSS-based OFDM transmission, wherein the transmitting uses at least one of:
   the FDSS filter with the determined adaptation applied thereto, or
   the spectral extension parameter with the determined adaptation applied thereto.

According to various, but not necessarily all, examples of the disclosure there is provided a method comprising:
transmitting, from an apparatus to a second apparatus, first information indicative of a capability of the apparatus to adapt at least one of:
   a frequency-domain spectral shaping, FDSS, filter for FDSS-based orthogonal frequency division multiplexing, OFDM, transmission, or
   a spectral extension parameter for use in FDSS-based OFDM with spectral extension transmission;
receiving, at the apparatus from the second apparatus based at least in part on the transmitted first information, second information, wherein the second information comprises information for configuring the apparatus to adapt at least one of the FDSS filter or the spectral extension parameter;
determining, at the apparatus, an adaptation to apply to at least one of the FDSS filter or the spectral extension parameter, wherein the determination is based at least in part on the received second information, and wherein the adaptation comprises adapting at least one of:
   at least one of a plurality of filter coefficients of the FDSS filter,
   at least one of one or more filter parameters, or
   the spectral extension parameter; and
transmitting, from the apparatus to the second apparatus, at least one FDSS-based OFDM transmission, wherein the transmitting uses at least one of:
   the FDSS filter with the determined adaptation applied thereto, or
   the spectral extension parameter with the determined adaptation applied thereto.

According to various, but not necessarily all, examples of the disclosure there is provided a chipset comprising processing circuitry configured to perform the above-mentioned method.

According to various, but not necessarily all, examples of the disclosure there is provided: an apparatus, a module, circuitry, a device and/or a system comprising means for performing the above-mentioned method.

According to various, but not necessarily all, examples of the disclosure there is provided a computer program comprising instructions, which when executed by an apparatus, cause the apparatus to perform the above-mentioned method.

According to various, but not necessarily all, examples of the disclosure there is provided an apparatus comprising:
at least one processor; and
at least one memory storing instructions that, when executed by the at least one processor, cause the apparatus at least to:
transmit, to a second apparatus, first information indicative of a capability of the apparatus to adapt at least one of:
   a frequency-domain spectral shaping, FDSS, filter for FDSS-based orthogonal frequency division multiplexing, OFDM, transmission, or
   a spectral extension parameter for use in FDSS-based OFDM with spectral extension transmission;
receive, from the second apparatus based at least in part on the transmitted first information, second information, wherein the second information comprises information for configuring the apparatus to adapt at least one of the FDSS filter or the spectral extension parameter;
determine an adaptation to apply to at least one of the FDSS filter or the spectral extension parameter, wherein the determination is based at least in part on the received second information, and wherein the adaptation comprises adapting at least one of:
   at least one of a plurality of filter coefficients of the FDSS filter,
   at least one of one or more filter parameters, or
   the spectral extension parameter; and
transmit, to the second apparatus, at least one FDSS-based OFDM transmission, wherein the transmitting uses at least one of:
   the FDSS filter with the determined adaptation applied thereto, or
   the spectral extension parameter with the determined adaptation applied thereto.

According to various, but not necessarily all, examples of the disclosure there is provided a non-transitory computer readable medium encoded with instructions that, when executed by at least one processor, causes at least the following to be performed:
transmitting, from an apparatus to a second apparatus, first information indicative of a capability of the apparatus to adapt at least one of:
   a frequency-domain spectral shaping, FDSS, filter for FDSS-based orthogonal frequency division multiplexing, OFDM, transmission, or
   a spectral extension parameter for use in FDSS-based OFDM with spectral extension transmission;
receiving, at the apparatus from the second apparatus based at least in part on the transmitted first information, second information, wherein the second information comprises information for configuring the apparatus to adapt at least one of the FDSS filter or the spectral extension parameter;
determining, at the apparatus, an adaptation to apply to at least one of the FDSS filter or the spectral extension parameter, wherein the determination is based at least in part on the received second information, and wherein the adaptation comprises adapting at least one of:
   at least one of a plurality of filter coefficients of the FDSS filter,
   at least one of one or more filter parameters, or
   the spectral extension parameter; and
transmitting, from the apparatus to the second apparatus, at least one FDSS-based OFDM transmission, wherein the transmitting uses at least one of:
   the FDSS filter with the determined adaptation applied thereto, or
   the spectral extension parameter with the determined adaptation applied thereto.

The following portion of this ‘Brief Summary’ section describes various features that can be features of any of the examples described in the foregoing portion of the ‘Brief Summary’ section mutatis mutandis. The description of a function should additionally be considered to also disclose any means suitable for performing that function, or any instructions stored in at least one memory that, when executed by at least one processor, cause an apparatus to perform that function.

In some but not necessarily all examples, the determination is based at least in part on a channel condition.

In some but not necessarily all examples, determining the adaptation comprises determining at least one of:
at least one of the plurality of filter coefficients of the FDSS filter to be used for the FDSS-based OFDM transmission;
a class of the FDSS filter;
at least one of one or more filter parameters for a class of filter of the FDSS filter to be used for the FDSS-based OFDM transmission;
the spectral extension parameter to be used for the FDSS-based OFDM with spectral extension transmission; or
a channel condition.

In some but not necessarily all examples, determining the adaptation comprises at least one of:
using a look-up table;
using an algorithm;
receiving, from the second apparatus information indicative of at least one of:
   at least one of the plurality of filter coefficients of the FDSS filter to be used for the FDSS-based OFDM transmission;
   at least one of the one or more filter parameters for the class of filter of the FDSS filter to be used for the FDSS-based OFDM transmission; or
   the spectral extension parameter to be used for the FDSS-based OFDM with spectral extension transmission.

In some but not necessarily all examples, the FDSS filter is a machine learning, ML, based FDSS filter, and wherein the plurality of filter coefficients of the FDSS filter are indicative of a plurality of weightings of an ML layer of the ML-based FDSS filter.

In some but not necessarily all examples, the FDSS filter is a class of filter whose plurality of filter coefficients are determined by one or more filter parameters for the class of filter.

In some but not necessarily all examples, the class of filter comprises at least one of the following:
a Root-Raised-Cosine, RRC, filter;
a Raised-Cosine, RC, filter; or
a Gaussian filter.

In some but not necessarily all examples, the one or more filter parameters for the class of filter comprises at least one of the following:
a roll-off factor;
a truncation factor; or
a standard deviation.

In some but not necessarily all examples, at least one of:
the plurality of filter coefficients of the FDSS filter, or
the one or more filter parameters for the class of filter of the FDSS filter are learnable via a machine learning, ML, model.

In some but not necessarily all examples, the FDSS filter is at least one of the following:
a Tx filter matched with a corresponding receive, Rx, filter of the second apparatus;
an adaptable filter of a transmission, Tx, chain;
configurable filter whose configured state is defined by a plurality of filter coefficients;
a configurable filter whose filter coefficients are determined based at least in part on one or more filter parameters;
a machine learning, ML, based filter; or
a configurable filter whose operation is determined by one or more filter parameters.

In some but not necessarily all examples, the first information comprises information indicative of one or more of the following:
a capability of the apparatus to perform FDSS-based OFDM transmission;
a capability of the apparatus to perform FDSS-based OFDM transmission with spectral extension;
a parameter indicative of a rate at which the FDSS filter can be adapted;
at least one indication of one or more filter parameters that the apparatus is capable of applying to the FDSS filter to adapt the FDSS filter;
at least one indication of one or more filter coefficients of the FDSS filter that the apparatus is capable of adapting;
one or more identifiers for identifying one or more configuration states that the FDSS filter is able to be adapted to;
one or more identifiers, wherein each identifier identifies a set of parameters for at least one of: characterizing, deploying or running an adapted FDSS filter; or
a set of a plurality of identifiers wherein each identifier identifies:
   a particular FDSS filter adaptation configuration for a transmission, Tx, FDSS filter, and
   a particular FDSS filter adaptation configuration for a receive, Rx, FDSS filter that is matched with the Tx FDSS filter.

In some but not necessarily all examples, the first information comprises information indicative of:
one or more spectral extension sizes supported by the apparatus.

In some but not necessarily all examples, the second information comprises information indicative of one or more of the following:
one or more adaptations of the FDSS filer that the apparatus is permitted to perform;
at least one parameter indicative of at least one rate at which the apparatus is permitted to adapt the FDSS filter;
at least one indication of one or more filter parameters that the apparatus is permitted to apply to the FDSS filter to adapt the FDSS filter;
at least one indication of one or more filter coefficients of the FDSS filter that the apparatus is permitted to adapt;
one or more identifiers identifying one or more configuration states that the FDSS filter is permitted to be adapted to;
one or more identifiers, wherein each identifier identifies a set of filter parameters that are permitted to be applied to the FDSS filter to adapt the FDSS filter, wherein the set of filter parameters are for at least one of: characterizing, deploying or running the adapted FDSS filter;
one or more identifiers, wherein each identifier identifies:
   a particular FDSS filter adaptation configuration that the FDSS filter is permitted to be adapted to, and
   a particular FDSS filter adaptation configuration for a receive, Rx, FDSS filter that is matched with the FDSS filter.

In some but not necessarily all examples, the second information comprises information indicative of one or more of the following:
one or more adaptations of a spectral extension parameter that the apparatus is permitted to perform; or
at least one extension size the apparatus is permitted to apply in FDSS-based OFDM transmission with spectral extension.

In some but not necessarily all examples, the transmitting of the at least one FDSS-based OFDM transmission comprises at least one of:
using the adapted FDSS filter in generating a waveform for FDSS-based OFDM transmission, or
using the adapted spectral extension parameter in performing spectral extension of FDSS-based OFDM transmission with spectral extension.

In some but not necessarily all examples, the apparatus further comprises:
means for receiving, from the second apparatus, third information, wherein the third information comprises information for indicting the apparatus to further adapt the FDSS filter; and
means for further adapting the FDSS filter, wherein the further adaptation is based at least in part on the third information.

In some but not necessarily all examples, the third information comprises information for indicating at least one of the following:
an indication of one or more filter parameters that the apparatus is to apply to the FDSS filter to further adapt the FDSS filter;
an indication of one or more filter coefficients of the FDSS filter that are to be further adapted;
that the apparatus is to revert to a fallback FDSS filter configuration or a fallback spectral extension parameter.

In some but not necessarily all examples, the FDSS-based OFDM transmission comprises at least one of:
an FDSS-based discrete Fourier transform spread orthogonal frequency division multiplexing, DFT-s-OFDM, transmission; or
FDSS-based Cyclic Prefix, CP, OFDM transmission.

According to various, but not necessarily all, embodiments there is provided an apparatus comprising means for performing at least part of one or more methods described herein. The description of a function and/or action should additionally be considered to also disclose any means suitable for performing that function and/or action. Functions and/or actions described herein can be performed in any suitable way using any suitable method.

According to various, but not necessarily all, embodiments there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all the features described in respect of other examples of the disclosure, and vice versa. Also, it is to be appreciated that any one or more or all the features, in any combination, may be implemented by/comprised in/performable by an apparatus, a method, and/or computer program instructions as desired, and as appropriate. The description of a function should additionally be considered to also disclose any means suitable for performing that function.

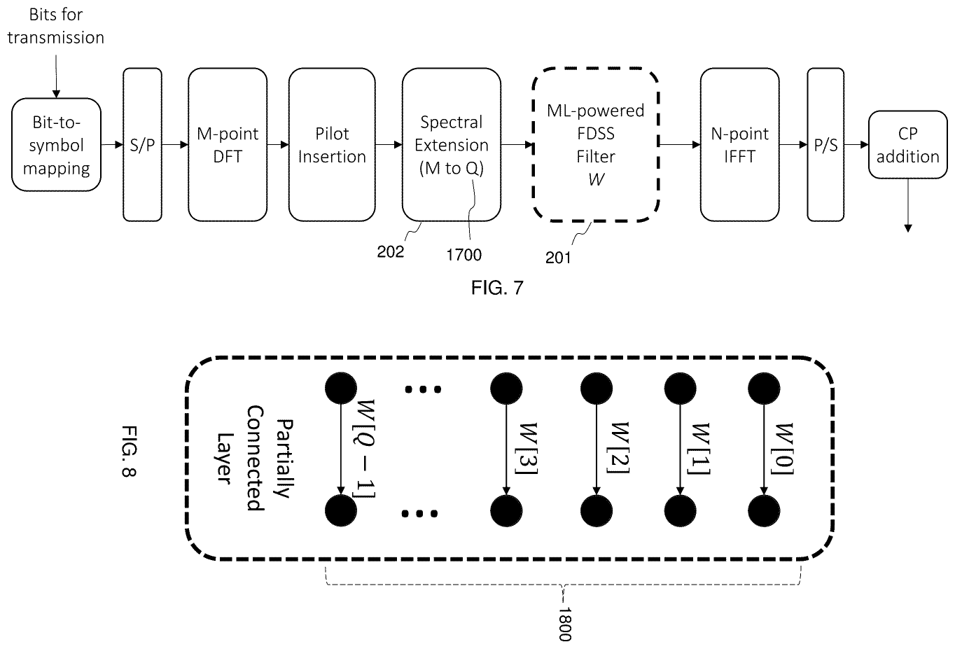

In the following description, the invention is described with reference to figures, not least in particular FIGS. 7 to 9, while the description of the remaining figures is provided for illustrative purposes for a better understanding of the invention.

### BRIEF DESCRIPTION

Some examples will now be described with reference to the accompanying drawings in which:

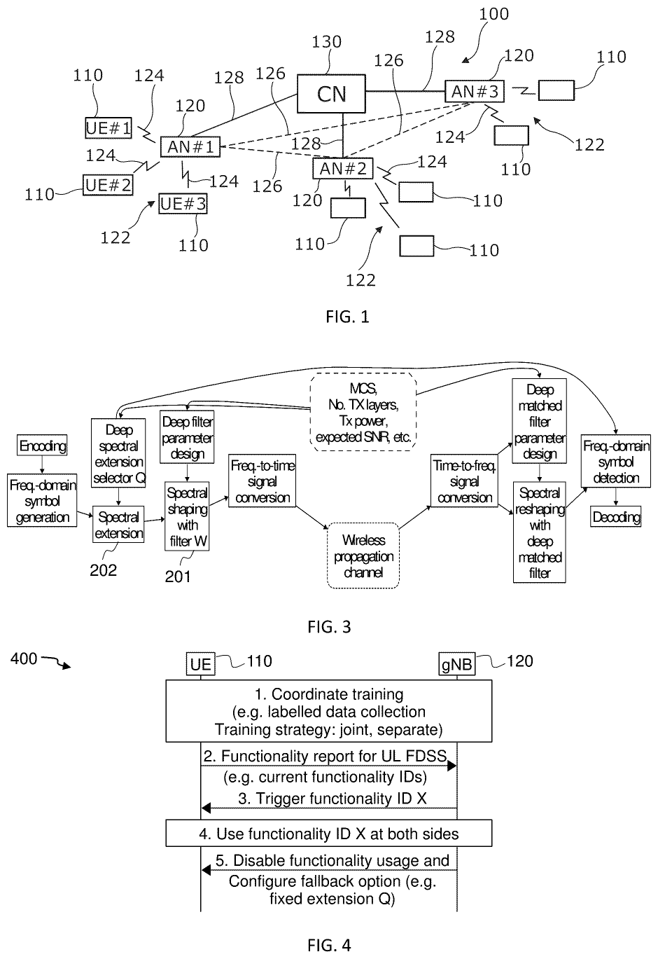

FIG. 1 shows an example of the subject matter described herein;

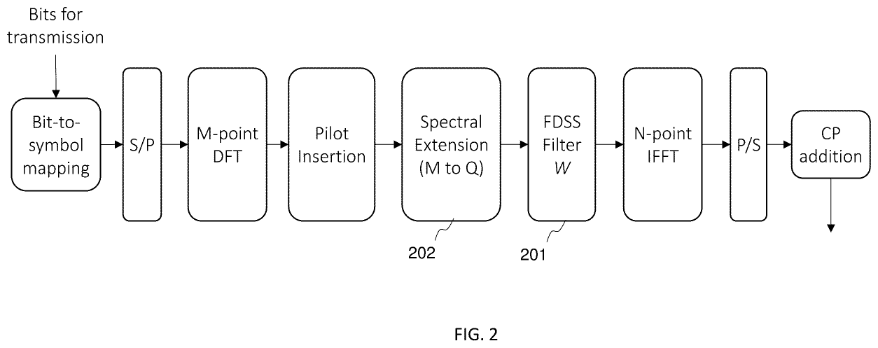

FIG. 2 shows another example of the subject matter described herein;

FIG. 3 shows another example of the subject matter described herein;

FIG. 4 shows another example of the subject matter described herein;

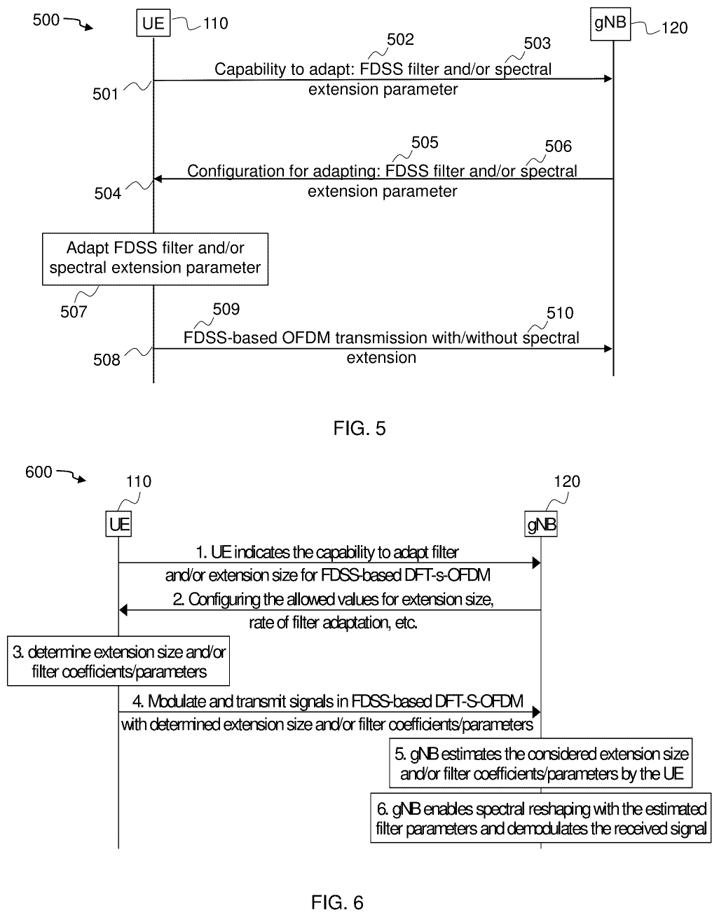

FIG. 5 shows another example of the subject matter described herein;

FIG. 6 shows another example of the subject matter described herein;

FIG. 7 shows another example of the subject matter described herein;

FIG. 8 shows another example of the subject matter described herein;

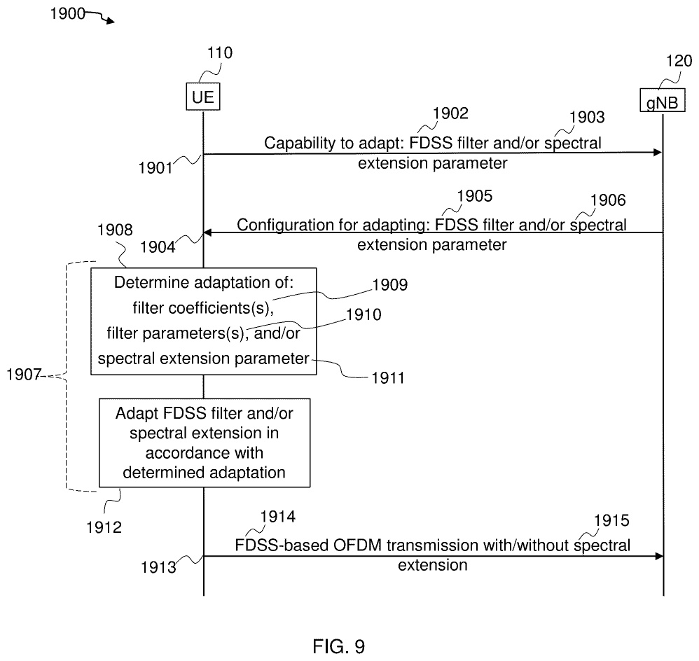

FIG. 9 shows another example of the subject matter described herein;

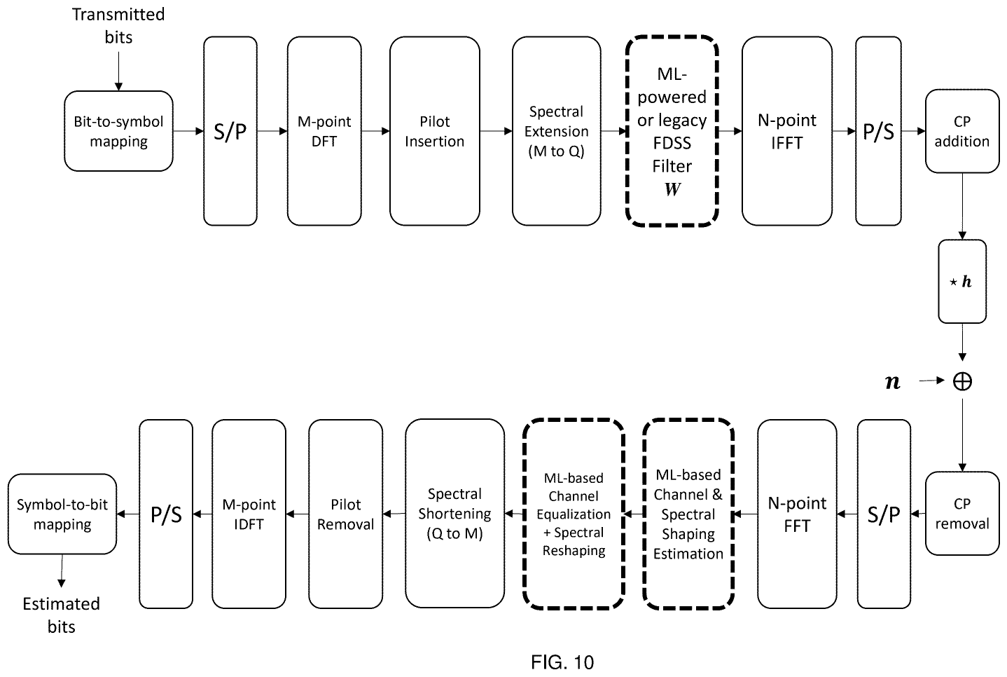

FIG. 10 shows another example of the subject matter described herein;

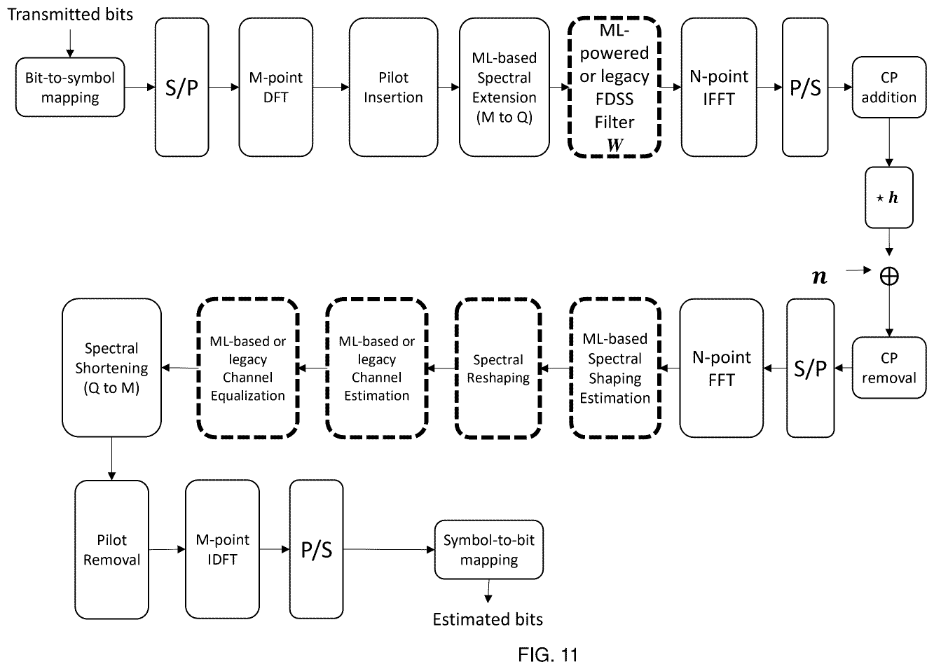

FIG. 11 shows another example of the subject matter described herein;

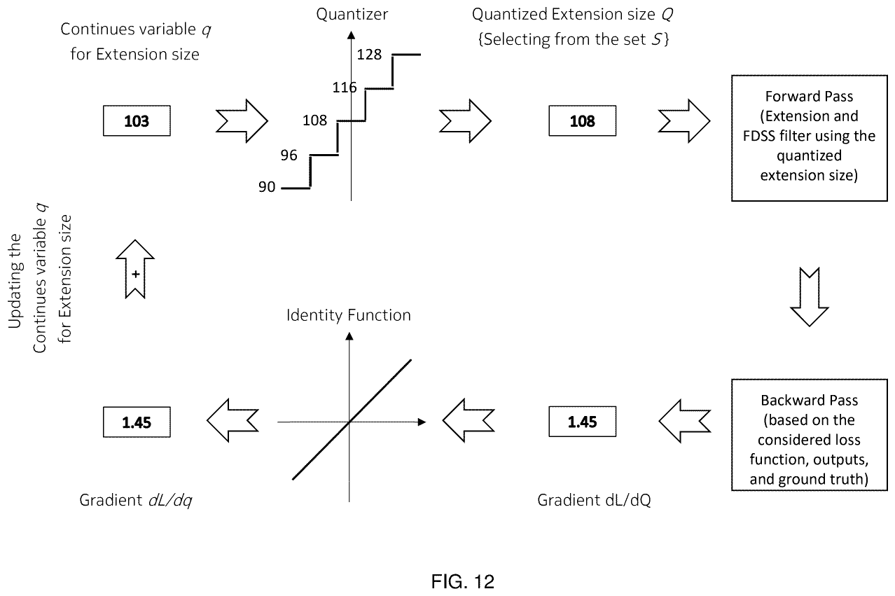

FIG. 12 shows another example of the subject matter described herein;

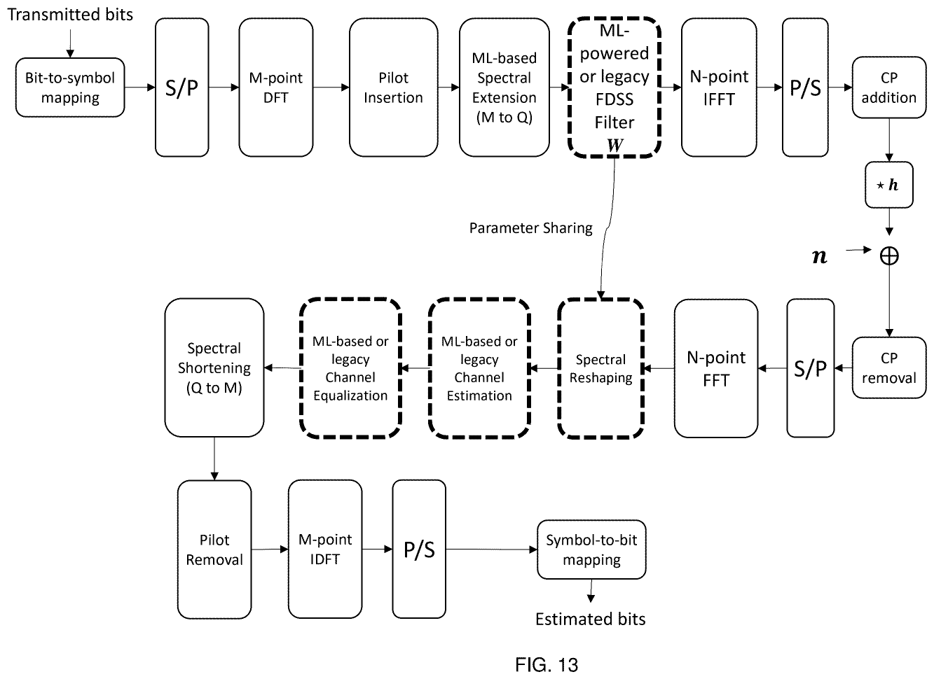

FIG. 13 shows another example of the subject matter described herein;

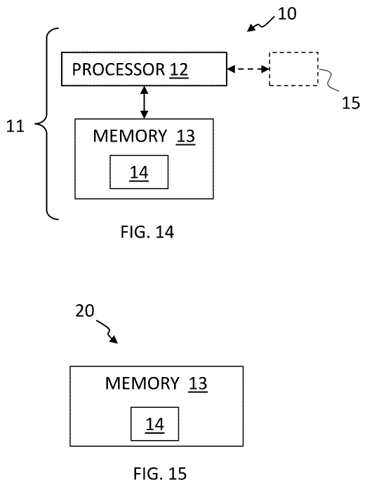

FIG. 14 shows another example of the subject matter described herein; and

FIG. 15 shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

ABBREVIATIONS/DEFINITIONS

| | |
|---|---|
| 3GPP | 3rd Generation Partnership Project |
| 5G | 5th Generation |
| ACLR | Adjacent Channel Leakage Ratio |
| AIML | Artificial Intelligence Machine Learning |
| BS | Base Station |
| CP-OFDM | Cyclic Prefix-OFDM |
| DFT | Discrete Fourier Transform |
| DFT-S-OFDM | DFT-spread-OFDM |
| FDSS | Frequency-Domain Spectral Shaping |
| gNB | Next generation NodeB, 5G/NR base station |
| ISSI | Inter Sub-Symbol Interference |
| MPR | Maximum Power Reduction |
| NE | Network Entity |
| NR | New Radio |
| NW | Network |
| OFDM | Orthogonal Frequency Division Multiplexing |
| PAR/PAPR | Peak-to-Average Power Ratio |
| PED | Power Envelope Distribution |
| RAN | Radio Access Network |
| RC | Raised-Cosine |
| RRC | Root-Raised-Cosine |
| Rx | Receive/Receiver |
| Tx | Transmit/transmitter |
| UE | User Equipment |
| UL | Uplink |

### DETAILED DESCRIPTION

FIG. 1 schematically illustrates an example of a network 100 suitable for use with examples of the present disclosure. The network (which may be referred to as NW) comprises a plurality of network entities (which may be referred to as NEs), including:
terminal apparatuses 110 (which may be referred to as terminal nodes or User Equipment, UE),
access apparatuses 120 (which may be referred to as access nodes, gNodeBs, gNBs, or Base Stations, BSs),
one or more core network apparatuses 130 (which may be referred to as core nodes, core functions, core entities or core network entities).

The terminal nodes 110 and access nodes 120 communicate with each other. The one or more core network nodes 130 may, in some but not necessarily all examples, communicate with each other. The one or more access nodes 120 may, in some but not necessarily all examples, communicate with each other.

The network 100, in the example illustrates in FIG. 1, comprises a radio telecommunications network in which at least some of the terminal nodes 110 and access nodes 120 communicate with each other using transmission/reception of radio waves. In this regard, the network 100 comprises a Radio Access Network, RAN, such as a cellular network comprising a plurality of cells 122 each served by an access node 120. The access nodes 120 comprise cellular radio transceivers. The terminal nodes 110 comprise cellular radio transceivers.

In the example illustrated and discussed below, the network 100 is a New Radio, NR, network of the Third Generation Partnership Project, 3GPP, and its fifth generation, 5G, New Radio, NR, technology. In other examples, the network 100 may be a network beyond 5G, for example a next generation (i.e. sixth generation, 6G) Radio Network that is currently under development (i.e. an evolution of the NR network and its 5G technology).

The interfaces between the terminal nodes 110 and the access nodes 120 are radio interfaces 124 (e.g., Uu interfaces). The interfaces between the access nodes 120 and one or more core nodes 130 are backhaul interfaces 128 (e.g., S1 and/or Next Generation, NG, interfaces).

Depending on the exact deployment scenario, the access nodes 120 may be RAN nodes such as NG-RAN nodes. NG-RAN nodes may be gNodeBs, gNBs, that provide NG user plane and control plane protocol terminations towards the UE. The gNBs are connected by means of NG interfaces to a 5G Core (5GC), not least for example to an Access and Mobility Management Function, AMF, by means of an NG Control Plane, NG-C, interface and to a User Plane Function, UPF, by means of an NG User Plane, NG-U, interface. The access nodes 120 may be interconnected with each other by means of Xn interfaces 126.

The cellular network 100 may be configured to operate in licensed frequency bands, or unlicensed frequency bands (not least such as: unlicensed bands that rely upon a transmitting device to sense the radio resources/medium before commencing transmission, such as via a Listen Before Talk, LBT, procedure; and a 60 GHz unlicensed band where beamforming may be required to achieve required coverage).

The access nodes 120 may be deployed in an NG standalone operation/scenario. The access nodes 120 may be deployed in a NG non-standalone operation/scenario. The access nodes 120 may be deployed in a Carrier Aggregation, CA, operation/scenario. The access nodes 120 may be deployed in a Dual Connectivity, DC, operation/scenario, i.e., Multi Radio Access Technology-Dual Connectivity, MR-DC, or NR-DC. The access nodes 120 may be deployed in a Multi Connectivity, MC, operation/scenario.

In such non-standalone/dual connectivity deployments, the access nodes 120 may be interconnected to each other by means of X2 or Xn interfaces, and connected to an Evolved Packet Core, EPC, by means of an S1 interface or to the 5GC by means of a NG interface.

A terminal node 110, in addition to being capable of communicating (i.e. with other terminal nodes) via access nodes 120 of the network 100, may also be capable of and configured to communicate directly with one or more other terminal nodes. In this regard, the terminal node may be capable of and configured to perform device-to-device, D2D, communication-which may be referred to as Sidelink, SL, communication. Such D2D/SL communication may use a PC5 interface. PC5 refers to a reference point where the terminal node communicates directly with another terminal node over a direct channel (i.e. communication via an access node is not required). D2D communications may be short-range, network-less, direct communications. SL in New Radio (NR) is defined in 3GPP's release 16 of 5G NR.

In the example of FIG. 1 the core node 130 is shown as a single entity. In some examples the core node 130 could be distributed across a plurality of entities. For example, the core node 130 could be cloud based or distributed in any other suitable manner. The core node/core entities may provide one or more functions, not least such as: User Plane Function UPF, Session Management Function SMF, Policy Control Function PCF, and Application Function AF.

The access nodes 120 are network elements in the network responsible for radio transmission and reception in one or more cells 122 to or from the terminal nodes 110. The access nodes 120 are the network termination of a radio link. Each access node may be a Transmission Reception Point, TRP, or may host one or more TRPs.

An access node 120 may be implemented as a single network equipment, or have a split architecture that is disaggregated/distributed over two or more access nodes, such as a Central Unit, CU, a Distributed Unit, DU, a Remote Radio Head-end, RRH, using different functional-split architectures and different interfaces.

The terminal nodes 110 are network elements in the network that terminate the user side of the radio link. They are devices allowing access to network services. Terminal node 110 functionalities may be performed also by Mobile Termination, MT, part of an Integrated Access and Backhaul, IAB, node. The terminal nodes 110 may be referred to as User Equipment, UE, mobile equipment, mobile terminals, or mobile stations.

The term ‘User Equipment’ may be used to designate mobile equipment comprising means, such as a smart card, for authentication/encryption etc. such as a Subscriber Identity Module, SIM. A SIM/SIM card can be a memory chip, a module, or a Universal Subscriber Identity Module (USIM). In some examples, the term ‘User Equipment’ can be used to designate a location/position tag, a hyper/smart, a hyper/smart sensor, or a mobile equipment comprising circuitry embedded as part of the user equipment for authentication/encryption such as a software SIM.

In the following description, a terminal node may be referred to simply as UE 110.

In the following description, an access apparatus/access node to a RAN (e.g. a cellular network not least such as a 5G or 6G next generation RAN) may be referred to simply as gNB 120.

There now follows a brief discussion of Discrete Fourier Transform spread Orthogonal Frequency Division Multiplexing, DFT-S-OFDM.

DFT-S-OFDM is an uplink, UL, waveform for 5G NR systems also known as: Single-Carrier OFDM, SC-OFDM; or Linearly-Precoded OFDM Access, LP-OFDMA. The waveform is used to increase UL coverage, allowing a UE to transmit at a higher power than when using the alternative Cyclic Prefix-Orthogonal Frequency Division Multiplexing, CP-OFDM-which is another UL waveform used both in NR UL and NR DL.

DFT-S-OFDM uses the concept of OFDM, however, an input signal is precoded so that the resultant OFDM output mirrors the characteristics of a single-carrier modulated signal within the same transmission bandwidth. Since DFT-S-OFDM uses OFDM as a main transmission modulation scheme, the advantages of OFDM (e.g. time-frequency user multiplexing, resistance to frequency-selective fading, and frequency-domain equalization) are preserved. DFT-S-OFDM may also be easier to implement than time-domain filter-based equalization.

An advantage of DFT-S-OFDM is a reduced peak-to-average power ratio, PAPR, in a transmit signal as compared to that found in conventional OFDM. One OFDM symbol contains a plurality of sinusoids with different frequencies and phases. The superposition of the plurality of sinusoids may occasionally result in constructive interference between sinusoids. This may produce a high peak amplitude relative to the average power of the signal, i.e. high PAPR. High PAPR can cause problems in both the digital and analog domains. In the digital domain, a high PAPR may cause an output signal to occasionally exceed a dynamic range of a digital-to-analog converter, DAC, when the digital signal is converted to an analog signal. This may saturate the digital output resulting in a type of distortion called clipping. In the analog domain, the output signal may occasionally enter a nonlinear amplification region in a power amplifier of the transmitter resulting in a nonlinear distortion that may create undesirable out-of-band emissions in the form of high-order harmonics.

Another advantage of DFT-S-OFDM is that it is robust against spectral nulls from frequency-selective fading. In conventional OFDM, a null in a subcarrier results in a loss of data in that subcarrier. However, in DFT-S-OFDM, an input signal is spread across plural subcarriers. Therefore, a null in a subcarrier also spreads across the subcarriers.

There now follows a brief discussion of Frequency-Domain Spectral Shaping, FDSS, based DFT-S-OFDM.

In order to reduce PAPR—and consequently reduce a required Power Amplifier, PA, backoff and Maximum Power Reduction, MPR—a frequency-domain spectral shaping technique can be employed on top of DFT-S-OFDM. Advantageously, this may enable an improvement in UL coverage.

FIG. 2, schematically illustrates a block diagram of a filter design for DFT-S-OFDM with FDSS.

FDSS block 201 (namely FDSS filter W) applies spectral shaping in the frequency domain. In this regard, in the FDSS filter, Fourier coefficients are multiplied with a window function which shapes a spectrum of the transmit, Tx, signal.

FDSS may provide UL coverage enhancement due to achieving low PAPR through frequency domain signal shaping using the filter W of FIG. 2. However, the signal shaping introduces Inter Sub-Symbol Interference, ISSI, as it reduces orthogonality between subcarriers. Subsequently, ISSI degrades reception performance by lowering the effective Signal-to-Interference-plus-Noise Ratio, SINR. To alleviate ISSI, a non-zero excess bandwidth may be applied (i.e. the spectral extension shown FIG. 2). In this regard M (data or reference) symbols are transmitted onto Q subcarriers, wherein the spectral extension parameter Q is greater than M. This provides a benefit in terms of both reducing the ISSI and PAPR, albeit at the expense of reduced spectral efficiency. However, applying a (Q-M) spectral extension may provide only a partial solution since ISSI is not completely removed (ISSI is worse for higher modulation orders—with closer modulation points). Hence, a transmitter may need to resort to using robust modulation schemes (e.g. π/2-BPSK or QPSK) at the expense of low throughput, in order to ensure that the receiver is able to correctly detect the symbols despite ISSI.

In the spectral extension block 202 of FIG. 2, a spectral extension may be applied prior to the FDSS block to provide FDSS-based DFT-S-OFDM with spectrum extension.

In further detail, one may consider a 6G UL FDSS transceiver capable of DFT-S-OFDM with FDSS UL transmission of B symbols per frame.

Consider [P] denotes a set {p∈ [symbol] |0≤p≤P}.

During an i^{th} transmission, i∈[B−1], a vector uᵢ∈{0, 1}^{K} of bits is encoded by a UE with a code rate R and interleaved into a vector:

$${c}_{i} = {[ {( {c}_{i}^{( 0 )} )}^{T} , … , {( {c}_{i}^{{N}_{D} - 1} )}^{T} ]}^{T} \qquad ( 1 )$$

$$with entries {c}_{i}^{( k )} ∈ {\{ 0 , 1 \}}^{Z} , k ∈ [ {N}_{D} - 1 ] , {RN}_{D} Z = K .$$

A symbol mapper [symbol] maps bits

$${c}_{i}^{( k )} to {x}_{i} [ k ] : {x}_{i} [ k ] = ℳ ( {c}_{i}^{( k )} ) \qquad ( 2 )$$

where [symbol] : {1,0}^{z}→S_{d} denotes a complex modulation mapping, and S_{d} is a complex symbol constellation with cardinality 2^{z}.

These are passed through a DFT block, the output of which reads:

$${\tilde{x}}_{i} ( k ) = \frac{1}{\sqrt{{N}_{D}}} {\sum }_{v = 0}^{{N}_{D} - 1} {x}_{i} [ v ] exp ( \frac{- j 2 π kv}{{N}_{D}} ) \qquad ( 5 )$$

Then, the vector \tilde{x}ᵢ is interleaved with a pilot vector. The resulting vector's m^{th} entry \tilde{x}ᵢ[m] is a pilot symbol if m∈P and a data symbol if m∈D. Here, P={p₀, . . . p_{N}_{ₚ}₋₁} and D={d₀, . . . , d_{N}_{_{D}}₋₁}, P∪D=[M−1], P∩D=Ø, are subsets of pilot and data indexes, respectively, the same as in the OFDM chain.

Then, \tilde{x}ᵢ may be extended with a prefix (last (Q−M)/2 samples of \tilde{x}ᵢ are copied in front) and a suffix (first (Q−M)/2 samples of \tilde{x}ᵢ are copied at the back), resulting in

$${\tilde{x}}_{i}^{ext} .$$

The extension is denoted by copying operation as

$${\tilde{x}}_{i}^{ext} = {f}_{Q} ( {\tilde{x}}_{i} ) .$$

A frequency domain spectral shaping filter W is applied to the potentially spectrally extended signal

$${\tilde{x}}_{i}^{ext} ,$$

by elementwise multiplication of entries in W and

$${\tilde{x}}_{i}^{ext} , i . e . , {x}_{Filtered} [ k ] = {\tilde{x}}_{i}^{ext} [ k ] W [ k ]$$

or equivalently: \tilde{x}_{Filtered}=diag(W)f_{Q}(\tilde{x}ᵢ).

The vector \tilde{x}_{Filtered} is passed through an N-point inverse discrete Fourier transform (DFT) block and the resulting vector sᵢ is prepended a μ-sample long cyclic prefix, CP.

Each symbol sᵢ in the B-long symbols frame is sent then by the UE over an UL channel with response composed of L multipath components:

$${g}_{i} ( τ ) = {\sum }_{l = 0}^{L - 1} {h}_{i} ( l ) δ ( τ - {τ}_{i} ( l ) ) \qquad ( 3 )$$

where hᵢ(l) and τᵢ(l) model a gain and a delay of the l^{th} multipath component.

The gNB observes a signal which is sampled at a rate

$$\frac{1}{{T}_{s}} ,$$

and CP samples are discarded.

The remaining samples are collected in B vectors that are passed through an N-point DFT block, at the output of which the received vector is:

$${y}_{i} = {H}_{i} {\tilde{x}}_{F i l t e r e d} + {n}_{i} \qquad ( 4 )$$

$$or equivalently :$$

$${y}_{i} = {H}_{i} diag ( W ) {f}_{Q} ( {\tilde{x}}_{i} ) + {n}_{i} \qquad ( 5 )$$

where: i∈[B−1] and the matrix Hᵢ∈ [symbol] ^{M×M} is diagonal, with diagonal entries:

$${H}_{i} [ m , m ] = \frac{1}{Q} {\sum }_{l = 0}^{L - 1} {h}_{i} ( l ) exp ( \frac{j 2 π p {τ}_{i} ( l )}{Q {T}_{s}} )$$

and vector nᵢ is Additive White Gaussian Noise, AWGN, with zero mean and variance σ²I_{N}.

With reference to the model/equation (5), the task for effecting FDL filtering (e.g. for an adaptable 6G UL FDSS transceiver) is:
to design the transmit filter W and the spectral extension f_{Q} and
to design a receiver that computes an approximation ûᵢ of the transmitted bits,
   for the unknown channel and noise conditions Hᵢ, nᵢ so that the UL performance is optimized e.g., bit error rate, BER, between the transmitted bit vector uᵢ and the estimated vector ûᵢ and PAPR of yᵢ are both minimized.

Given the complexity of the task, AIML-based solutions (for instance deep/AIML Tx and deep/AIML Rx which may involve deep neural network-based design of Tx and/or Rx chains) are proposed as candidates for the task at hand, i.e. for:
designing the filter W and spectral extension parameter Q at a UL TX, and
decoding the UL signal at a UL Rx without knowledge of the filter design.

It is not straightforward how to optimally design a filter W of a transmitter (e.g. not least the filter type and its filter parameters (which may also be referred to a “hyper parameters”) that effect the spectral shaping it applies), nor how to select the spectral extension parameter Q for each Modulation Coding Scheme, MCS, so that a receiver (e.g. gNB) might achieve the best UL performance regardless of the wireless propagation conditions, while simultaneously controlling for low PAPR and high spectral efficiency.

Various examples of the present disclosure seek to address/mitigate the above-described issues. Various examples of the present disclosure seek to provide a signaling framework for supporting a transceiver architecture capable of adaptive FDSS-based OFDM transmission, e.g. such as adaptive FDSS-based DFT-S-OFDM with or without spectrum extension. The FDSS filter may be adaptive in that its filter design (e.g. its operational parameters that effect/determine/define the spectral shaping applies) can be adapted/modified. In this regard, the adaptable/adjustable operational parameters may include: filter coefficients, which define the state/configuration of the FDSS filter, being able to be adjusted/modified; or filter parameters, which determine/control the filter coefficients, being able to be adjusted/modified). Also, the spectral extension parameter may also be able to be adjusted/modified.

A transceiver chain for generating an FDSS-DFT-s-OFDM waveform has a filter F that shapes the signal in frequency domain (spectral shaping) and an extension parameter Q in frequency domain. The filter coefficients and the extension parameter can be adapted, i.e. tuned/set, based on at least: prevailing channel conditions and received configurations (e.g., allowed range for Q) from the gNB. An FDSS filter may be considered to be adaptive if it is able to tune/set its filter coefficients and extension parameter for the FDSS-DFT-s-OFDM waveform (e.g. based on information received from the gNB), and the UE may update/adapt its filter coefficients/parameters based on channel conditions and/or others objectives. It is to be appreciated that changing the extension parameter Q leads to different number of coefficients in the FDSS filter. Accordingly, the FDSS filter design depends on the choice for Q.

As will be discussed in further detail below, and as schematically shown in FIG. 3, the present disclosure provides a new UL FDSS transceiver architecture that is supported by a new signaling framework (e.g. for use in a 6G RAN) that:
1. Implements deep spectral shaping (i.e. AI/ML-based spectral shaping) using either:
   a. A filter or series of filters (filter bank) of known class (e.g., root raised cosine) with learnable filter parameters (i.e. filter parameters that determine the filter's coefficients: {w1, . . . , wk}) that are learnt by means of machine learning/deep learning.
   b. A learnable filter i.e., the filter's coefficients {w1, . . . , wk} are directly learned by means of machine learning/deep learning.
2. Assesses a need for, and selects a spectral extension parameter, i.e. total size [symbol] , from a set of allowed values S={M, [symbol] 1, . . . , [symbol] N}, wherein Q1, . . . , QN are integers larger than M, and wherein the set S may pre-configured by the gNB via signaling (it being appreciated that a selection of M form Set S results in FDSS without spectral extension, i.e. Q=M such that there would be no spectral extension). The selection may be done dynamically by the gNB and communicated to a UE or vice versa.
3. Implements a deep (AI/ML) matched filtering operation in the receiver prior to applying standard channel estimation and symbol detection.
   a. This operation may also be seen as an ISSI cancellation step and targets to enable the transceiver to operate with higher order modulations.
4. Tunes Tx and Rx deep processors (e.g. an AI/ML Tx and an AI/ML Rx) to at least:
   a. a (variable) modulation and coding scheme, and
   b. channel and noise conditions
   c. number of transmit layers and transmit power etc.
      while targeting to reduce PAPR and optimize UL throughput.
5. Requires coordination between the UE and the gNB to train, deploy, use, and maintain the deep Tx and Rx, either by acting in a separate manner or jointly.
   a. In particular, the gNB and UE may agree on a set of common constraints and/or design considerations, and coordinate the selection of the filter type and size, and spectral extension depending on the gNB selection for the UL TX configuration like:
      i. MCS
      ii. UL TX power
      iii. Number of TX layers
      iv. Expected SNR (as anticipated by the gNB), etc.

FIG. 4 illustrates a generic signalling framework 400, between a UE and its serving gNB, for supporting the deployment of adaptable UL FDSS filtering.

To support training of a deep/AIML model for adaptable UL FDSS filtering of by a 6G UL FDSS transceiver over the air interface, a dedicated procedure of generating labelled training data may be required. The deep/AIML model may be separate to an adaptable FDSS transceiver and configured for outputting filter parameters or filter coefficients for configuring the adaptable FDSS transceiver (e.g. to provide a particular spectral shape), or the deep/AIML model may be integrated with the adaptable FDSS transceiver i.e. so as to provide a deep/AIML FDSS transceiver.

The labelling of the data would need to be agreed between the UE and the gNB and may be realized via a handshake procedure over a dedicated control or data channel. More details on the specifics of the training data labelling and acquisition are discussed later on below.

Block 1 schematically illustrates coordinated training (i.e. labelled data collection for a given training strategy: e.g. joint or separate) taking place between a UE and its service gNB.

Once the training is completed, the UE and gNB's matched/paired models (for adaptive FDSS: Tx and Rx) are assigned a paired functionality ID, via which the models are uniquely identified. The functionality ID may be indicative of a particular spectral shape. The functionality ID may correspond to a complete set of parameters required to deploy and run the model in the UE and the gNB respectively. For example, the UE/gNB functionality ID may be a data structure containing:
UE/gNB assistance information e.g., MCS, extension Q, etc.
a functionality switching latency (indicative of how quickly FDSS filtering can be adapted by an adaptive FDSS transceiver, i.e. how quickly an FDSS transceiver can switch from applying one particular spectral shape to another).

In block 2, the UE sends (e.g. via a Radio Resource control, RRC, Information Element, IE) to the gNB, a UE functionality report. With this report, the UE is able to indicates, to the gNB, its ability to adapt its FDSS filter. The UE's functionality report may include a rate of adaptation that the UE is capable of (e.g., how fast it can switch to a new FDSS filter type/design/configuration). The functionality report may be sent implicitly, for instance by sharing a list of the functionality IDs that the US currently supports, e.g. such as those which were obtained during the training period (and which may fully characterizes the UE's FDSS filter model capabilities e.g.: input, output, extension Q size, etc.).

In block 3, the gNB may configure adaptive filtering by selecting a functionality ID from the list of functionality IDs and trigger the UE to use the selected functionality ID. Such configuration may be a new RRC configuration.

In block 4, the gNB may then activate its matched gNB functionality ID, to process transmissions received from the UE that use a waveform generated by the UE using matched UE functionality ID so as to provide UE adaptive filtering.

In block 5, at any time during the UL transmission, the gNB may interrupt the functionality if the gNB deems the performance as being unsatisfactory. In this case, an RRC IE indicative of a functionality interruption may be transmitted to the UE, which may include a fallback option e.g.:
a. a fixed/default filter setting, including a fixed/default spectral extension size.

To support an inference aspect of the proposed framework, dedicated procedures and signaling are provided as shown in FIGS. 5 and 6 and as discussed below.

FIG. 5 illustrates an example of a signaling diagram, showing signalling between a UE and its serving gNB and a procedure 500, for supporting inference using adaptable FDSS filters, such as ML-based FDSS filters, at the UE and/or the gNB.

In block 501, the UE 110 transmits first information to the gNB, wherein the first information comprises a capability report that comprises:
capability information 502 indicative of a capability of the UE to adapt a design of the UE's FDSS filter for FDSS-based OFDM transmission, and/or
capability information 503 indicative of a capability of the UE to adapt a spectral extension parameter (e.g. spectral extension size Q), for use in FDSS-based OFDM with spectral extension transmission.

The FDSS filter may be at least one of the following:
a Tx filter matched with a corresponding receive, Rx, filter of the gNB;
an adaptable filter of a transmission, Tx, chain;
a deep/AI/ML-based filter;
a configurable filter whose operation is determined by one or more parameters (such parameters may be operational parameters that effect the FDSS filter's operation/behaviour [i.e. the spectral shape applied] and may include for example: bit or block error rate, BER or BLER, at Rx; Adjacent Channel Leakage Ratio, ACLR, at TX; PAPR and/or Power Envelope Distribution, PED);
a configurable filter whose configured state is defined at least in part by one or more filter coefficients (i.e. coefficient value at subcarrier k for spectral shaping of a signal at subcarrier k so as to directly amplify or attenuate the signal level at subcarrier k); or
a configurable filter whose filter coefficients are determined at least in part by one or more filter parameters (i.e. parameters that control the values of filter coefficient at different subcarriers).

The FDSS-based OFDM transmission may be:
an FDSS-based discrete Fourier transform spread orthogonal frequency division multiplexing, DFT-s-OFDM, transmission; or
an FDSS-based Cyclic Prefix, CP, OFDM transmission.

The first information may comprises information indicative of one or more of the following:
a capability of the UE to perform adaptive FDSS-based OFDM transmission;
a capability of the UE to perform FDSS-based OFDM transmission with adaptive spectral extension;
a rate at which the UE can adapt its FDSS filter design (i.e. the UE's functionality switching latency indicating how fast the UE's filter can switch between differing types/designs/spectral extensions);
an indication of one or more filter parameters that the UE is capable of applying to the FDSS filter design to adapt the FDSS filter design;
an indication of one or more filter coefficients of the FDSS filter that the UE is capable of adapting;
one or more identifiers (e.g. functionality IDs) for identifying one or more configuration states that the FDSS filter design is able to be adapted to (Such identifiers may identify a complete set of parameters for: characterizing, deploying and/or running an adapted FDSS filter design at each of the UE and gNB. Such a set of parameters may comprise or consist of one or more of: input(s) to an AI/ML model for adapting an adaptive FDSS filter; output(s) from an AI/ML model for adapting an adaptive FDSS filter; extension Q size; functionality switching latency; MCS; UE mobility; number of Tx layers; multiple-input and multiple-output, MIMO, layers; Tx power; expected SNR and channel conditions);
a set of a plurality of identifiers (e.g. a list of functionality IDs) wherein each identifier identifies:
a particular FDSS filter design adaptation configuration for a transmission, Tx, FDSS filter design, and
a particular FDSS filter design adaptation configuration for a receive, Rx, FDSS filter design that is matched with the Tx FDSS filter design; and
one or more extension sizes supported by the UE.

In block 504, based at least in part on the transmitted first information, the UE receives second information from the gNB, wherein the second information comprises:
configuring information 505 for configuring the UE to adapt the FDSS filter design, and/or
configuring information 506 for configuring the UE to adapt the spectral extension parameter.

The second information may comprise adaptation information indicating an adaptation to be applied to the UE's FDSS filter or the spectral extension size to be employed. The adaptation information may be indicated by indicating a functional ID that the UE supports.

The second information may comprise information indicative of one or more of the following:
one or more adaptations of the FDSS filer that the UE is permitted to perform; at least one rate at which the UE is permitted to adapt the FDSS filter design (e.g. a permissible functionality switching latency);
at least one indication of one or more filter parameters that the UE is permitted to apply to the FDSS filter design to adapt the FDSS filter design;
at least one indication of one or more filter coefficients of the FDSS filter design that the UE is permitted to adapt;
one or more identifiers (e.g. functionality IDs) identifying one or more configuration states that the FDSS filter design is permitted to be adapted to;
one or more identifiers, wherein each identifier identifies a set of parameters (such parameters corresponding to: input(s), output(s), extension Q size, MCS, UE mobility, number of Tx/MIMO layers, SNR channel conditions as mentioned above) that are permitted to be applied to the FDSS filter design to adapt the FDSS filter design, wherein the set of parameters are for at least one of: characterizing, deploying or running the adapted FDSS filter design;
one or more identifiers (e.g. functionality IDs), wherein each identifier identifies:
a particular FDSS filter design adaptation configuration that the FDSS filter design is permitted to be adapted to, and
a particular FDSS filter design adaptation configuration for a receive, Rx, FDSS filter design that is matched with the FDSS filter design; and
one or more adaptations of the spectral extension parameter that the UE is permitted to perform; and/or
a set of one or more extension sizes that the UE is permitted to apply in FDSS-based OFDM transmission with spectral extension.

In block 507 the UE adapts:
the FDSS filter design, and/or
the spectral extension parameter
   wherein the adaptation is based at least in part on the received second information.

The adapting of the FDSS filter design and/or the spectral extension parameter may comprise determining one or more filter parameters to be applied to the FDSS filter design to adapt the FDSS filter design, wherein the one or more filter parameters are determined based at least in part on, or received in, the received second information.

The adapting of the FDSS filter design and/or the spectral extension parameter may alternatively or additionally comprise determining one or more filter coefficients to be applied to the FDSS filter design to adapt the FDSS filter design, wherein the one or more filter coefficients are determined based at least in part on the received second information. In some examples, the UE may determine the filter coefficients based on a selected extension size, a type of filter class (e.g., RRC filters), and a filter parameter (e.g. roll-off factor for RRC filters). In some examples, for ML-based filters, the filter coefficients may be obtained after executing a training procedure. In some examples, the gNB may have previously shared a lookup table with the UE, and the UE selects a filter parameter from such table. The UE may also determine/observe channel conditions and the UE may also change filter coefficients based on the channel conditions.

The adapting of the FDSS filter design and/or the spectral extension parameter may also comprise determining a spectral extension parameter to be used for FDSS-based OFDM transmission with spectral extension, wherein the spectral extension parameter is determined based at least in part on the received second information.

In block 508 the UE transmits, to the gNB, one or more FDSS-based OFDM transmissions 509, wherein such transmission use:
the adapted FDSS filter design, and/or
the adapted spectral extension parameter (in this regard, the OFDM transmissions may be with or without spectral extension depending on the spectral extension parameter value Q used, e.g. where Q=M no spectral extension would be applied).

The transmission of the one or more FDSS-based OFDM transmissions may comprises at least one of:
the UE using the adapted FDSS filter design in generating a waveform, via a Tx chain comprising the adapted FDSS filter, and/or
the UE using the adapted spectral extension parameter in performing spectral extension of FDSS-based OFDM transmission with spectral extension.

In some examples (not shown in FIG. 5), the gNB estimates/infers, based at least in part on the received transmission of block 508, the adaptation that the UE has applied to the UE's FDSS filter design, and/or the spectral extension parameter the UE used.

Such estimation of the adaptation applied by the UE to its FDSS filter design may comprise the gNB estimating one or more filter parameters and/or filter coefficients used by the UE for its FDSS filter design used for the FDSS-based OFDM transmission of block 508.

Responsive to the gNB's estimation of the filter parameters and/or filter coefficients used by the UE, the gNB may adapt:
its own FDSS filter design it uses for FDSS-based OFDM reception, and/or
the spectral extension parameter its uses for FDSS-based OFDM with spectral extension reception.

The gNB may then determine bits encoded in the UE's FDSS-based OFDM transmission using its adapted FDSS filter design and/or its adapted spectral extension parameter.

In some examples (not shown in FIG. 5), the UE may receive, from the gNB, third information, wherein the third information comprises information for indicting the apparatus to further adapt the FDSS filter design and/or the spectral extension parameter. Responsive to receipt of the same, the UE may further adapt the FDSS filter design, or the spectral extension parameter in accordance with the recited information.

The third information may comprises information for indicating:
filter parameters that the UE is to apply to the FDSS filter design to further adapt the FDSS filter design;
filter coefficients of the FDSS filter design that are to be further adapted; and/or that the UE is to revert to a fallback FDSS filter design configuration or a fallback spectral extension parameter (in this regard, the third information may be a functionality interruption/disable functionality message for indicating to the UE that it is to cease adaptation of the FDSS filter and revert to a pre-determined or default/backup fixed adaptation).

FIG. 6 illustrates a further example of a signaling diagram, showing signalling between a UE and its serving gNB and a procedure 600, for supporting inference using adaptable FDSS filters, such as ML-based FDSS filters, at the UE and the gNB

In block 1 (which broadly corresponds to block 501 of FIG. 5), at a time of inference, the UE indicates its capability of transmitting with a FDSS-based DFT-s-OFDM waveform. The UE also indicates its capability to adapt its FDSS filter and/or an extension size for FDSS-based DFT-s-OFDM with/without spectral extensions.

In block 2 (which broadly corresponds to block 504 of FIG. 5), the gNB configures the UE with allowed values for extension size Q, a rate of filter adaptation, etc.

In block 3 (which broadly corresponds to block 507 of FIG. 5), the UE determines/obtains/selects an extension size (i.e. an optimal/proper extension size) from the allowed set received from the gNB. The UE also determines/obtains/selects filter coefficients/parameters (i.e. optimal/proper filter coefficients/parameters). In this regard, the UE may select an extension size Q from the list of permissible extension sizes and then the UE may configure the FDSS filter coefficients/parameters for its FDSS filter accordingly in view of the selected extension size Q.

In block 4 (which broadly corresponds to block 508 of FIG. 5), the UE modulates and transmits signals using FDSS-based DFT-S-OFDM with the determined extension size and/or the determined filter coefficients/parameters.

In block 5, the gNB process the received signal to estimate/infer a considered extension size and/or filter coefficients/parameters used by the UE.

In block 6, the gNB uses deep matched filters to apply spectral reshaping with the estimated filter parameters. The gNB then demodulates the outputs of deep matched filter to extract the transmitted bits in the transmits signals.

The now follows a discussion of implementational details for each of the above discussed aspects (i.e. inference, data collection, training and monitoring).

FIG. 7 schematically illustrates the main blocks of a UE's Tx chain for FDSS-based DFT-s-OFDM modulation with an ML-powered FDSS spectral shaping filter W 201 and also a spectral extension block 202 for effecting spectral extension (i.e. applying an M to Q spectral extension, wherein Q is a spectral extension size parameter 1700).

FIG. 8 schematically illustrates implementation details of an ML-powered FDSS filter, which have arbitrary filter coefficients.

ML capabilities (e.g. an AI/ML model) can be used to optimize the coefficients of the spectral reshaping filter W 201. In one example implementation, a specific ML layer can be considered to mimic the operations of a spectral reshaping filter as per that of FIG. 8.

In the example implementation shown, W[k], k=0, . . . , Q−1 are independent variables that can take any real values. Thus, a transmitted signal can be written as

$${s}_{i} ( t ; W ) = f ( u , M , W [ 0 ] , … , W [ Q - 1 ] )$$

Therefore, the variables W[0], . . . , W[Q−1], beside other potential trainable parameters in the transceiver chain, can be optimized in a training phase. The biases of the output neurons of the specific layer can be set to zero and ben excluded from the trainable set of variables. Alternatively, the ML-based filter can be designed/implemented using fully connected layer(s) or other types of ML layers with some trainable parameters.

The UE and gNB can train their models/trainable blocks of their transceiver chains (e.g. not least blocks 201 and 202) either jointly or separately.

In a joint training scheme, gradients need to be transferred between the UE and gNB over the air. Alternatively, the UE and gNB can train their models/trainable blocks separately, which would require no gradient sharing over the air, and consequently, would prevents large overhead to the network.

A loss function for optimizing the trainable parameters can include, at least:
BER or BLER at Rx,
ACLR at Tx, and
PAPR and/or power envelope distribution, PED, at Tx.

For example, cross entropy over transmitted and estimated bits can be defined as a main term of a loss function with some penalty constraints on the ACLR and the PED as the following:

$$\begin{matrix} & & {min}_{W , ψ} CE ( W , ψ ) \\ Subject to : & ACLR ( W ) \leq {ϵ}_{1} & \\ & PED ( W ) \leq {ϵ}_{2} & \end{matrix}$$

where CE(W, ψ) is a cross entropy between a transmitted bit and a received bit, averaged over all the data resource elements in D and all the B bits in each symbol.

$$CE ( W , ψ ) = - \frac{1}{{N}_{D} B} {\sum }_{( d ) ∈ D} {\sum }_{b = 0}^{B - 1} ( {b}_{l}^{( d )} log {\hat{b}}_{l}^{( d )} + ( 1 - {b}_{l}^{( d )} ) log ( 1 - {\hat{b}}_{l}^{( d )} ) ) ,$$

where ND denotes the number of resource elements for data transmission.

Also, the ACLR can be defined as

$$\begin{matrix}ACLR ( W ) = \frac{{E}_{O} ( W )}{{E}_{I} ( W )} = \frac{1 - {E}_{I} ( W )}{{E}_{I} ( W )} = \frac{1}{{E}_{I} ( W )} - 1 , \\ {E}_{I} ( W ) = 2 {\int }_{{f}_{L}}^{{f}_{H}} {\vert S ( f ; W ) \vert}^{2} d f\end{matrix}$$

where S (f; W) is a Fourier transform of s (t; W). Note we consider unit energy for the transmitted signal, i.e.,

$${\int }_{- ∞}^{∞} {\vert S ( f ; W ) \vert}^{2} d f = 1 .$$

Similarly, the PED constraint can be defined to control a variance of a power of the transmitted signal as

$$\begin{matrix}PED ( W ) = 𝔼 [ Var ( p ( t ; W ) ) ] = \frac{{\sum }_{i} {{p}_{i} ( t ; W )}^{2}}{N} - {( \frac{{\sum }_{i} {p}_{i} ( t ; W )}{N} )}^{2} , \\ {p}_{i} ( t ; W ) = {\vert {s}_{i} ( t ; W ) \vert}^{2}\end{matrix}$$

Using the Lagrange multiplier technique, the constraints can be included in the objective function. Thus, the modified objective function can be used as the loss function during training, i.e.,

$$ℒ ( W , ψ ; {λ}_{1} , {λ}_{2} ) = C E ( W , ψ ) + {λ}_{1} ( ACLR ( W ) - {ϵ}_{1} ) + {λ}_{2} ( P E D ( W ) - {ϵ}_{2} ) ,$$

where λ₁ and λ₂ are Lagrange parameters and can be trained during a training/optimization procedure.

In instances where the UE considers a specific type of filter for its FDSS block 201, the filter coefficients W[k], k=0, . . . , Q−1, depend on hyper parameters of the filter θ. For example, for an RRC filter, a roll-off factor β and a truncation factor ρ control the filter coefficients, so θ={β, ρ}.

Accordingly, the filter coefficients W[k], k=0, . . . , Q−1 for an RRC filter can be written as:

$$W [ k ] = \{ \begin{matrix}1 , & 0 \leq \vert \frac{k - Q / 2}{Q / 2} \vert \leq \frac{1 - β}{2} \\ cos ( \frac{π}{2 β} ( \vert \frac{k - Q / 2}{Q / 2} \vert - \frac{1 - β}{2} ) ) , & \frac{1 - β}{2} \leq \vert \frac{k - Q / 2}{Q / 2} \vert \leq \frac{1 - β}{2} \\ 0 , & \vert \frac{k - Q / 2}{Q / 2} \vert > \frac{1 - β}{2} .\end{matrix}$$

As the transmitted signal can be written as sᵢ=f(u, M, θ), the filter coefficients W[k], k=0, . . . , Q−1 cannot take arbitrary values and cannot be trained directly during the training phase. Instead, the hyper parameters for a particular filter type are considered as trainable parameters and will be trained.

Consider loss function [symbol] for training the learnable blocks (e.g., cross entropy over the transmitted and received bits and/or PAPR of the transmitted signal). Using a back propagation technique, gradients of the considered loss [symbol] with respect to the filter coefficients W,

$$i . e . , \frac{\partial ℒ}{\partial θ}$$

can be calculated.

To update the hyper parameters of the filter θ, a chain rule can be used as

$$\frac{\partial ℒ}{\partial θ} = \frac{\partial ℒ}{\partial W} \frac{\partial W}{\partial θ}$$

and then the new parameters are:

$${θ}^{n e w} = {θ}^{o l d} - α \frac{\partial L}{\partial θ}$$

where α denotes the learning rate.

FIG. 9 illustrates an example implementation of a signaling diagram, showing signalling between a UE and its serving gNB and a procedure 1900, for supporting inference using adaptable FDSS filters, such as ML-based FDSS filters, at the UE and/or the gNB.

In block 1901, the UE 110 transmits first information to the gNB, wherein the first information comprises a capability report that comprises:
capability information 1902 indicative of a capability of the UE to adapt a design of the UE's FDSS filter for FDSS-based OFDM transmission, and/or
capability information 1903 indicative of a capability of the UE to adapt a spectral extension parameter (e.g. spectral extension size Q), for use in FDSS-based OFDM with spectral extension transmission.

In this implementation, the FDSS filter is:
a configurable filter whose configured state is defined by a plurality of filter coefficients (e.g. W); or
a configurable filter whose plurality of filter coefficients are determined by one or more filter parameters (e.g. hyper parameters as discussed above).

The FDSS filter may be at least one of the following:
a Tx filter matched with a corresponding receive, Rx, filter of the gNB;
an adaptable filter of a transmission, Tx, chain;
a deep/AI/ML-based filter;
a configurable filter whose operation is determined by one or more parameters (such parameters may be operational parameters that effect the FDSS filter's operation/behaviour [i.e. the spectral shape applied] and may include for example: bit or block error rate, BER or BLER, at Rx; Adjacent Channel Leakage Ratio, ACLR, at TX; PAPR and/or Power Envelope Distribution, PED);
a configurable filter whose configured state is defined at least in part by one or more filter coefficients (i.e. coefficient value at subcarrier k for spectral shaping of a signal at subcarrier k so as to directly amplify or attenuate the signal level at subcarrier k); or
a configurable filter whose filter coefficients are determined at least in part by one or more filter parameters (i.e. parameters that control the values of filter coefficient at different subcarriers).

The FDSS-based OFDM transmission may be:
an FDSS-based discrete Fourier transform spread orthogonal frequency division multiplexing, DFT-s-OFDM, transmission; or
an FDSS-based Cyclic Prefix, CP, OFDM transmission.

The first information may comprises information indicative of one or more of the following:
a capability of the UE to perform adaptive FDSS-based OFDM transmission;
a capability of the UE to perform FDSS-based OFDM transmission with adaptive spectral extension;
a rate at which the UE can adapt its FDSS filter design (i.e. the UE's functionality switching latency indicating how fast the UE's filter can switch between differing types/designs/spectral extensions);
an indication of one or more filter parameters that the UE is capable of applying to the FDSS filter design to adapt the FDSS filter design;
an indication of one or more filter coefficients of the FDSS filter that the UE is capable of adapting;
one or more identifiers (e.g. functionality IDs) for identifying one or more configuration states that the FDSS filter design is able to be adapted to (Such identifiers may identify a complete set of parameters for: characterizing, deploying and/or running an adapted FDSS filter design at each of the UE and gNB. Such a set of parameters may comprise or consist of one or more of: input(s) to an AI/ML model for adapting an adaptive FDSS filter; output(s) from an AI/ML model for adapting an adaptive FDSS filter; extension Q size; functionality switching latency; MCS; UE mobility; number of Tx layers; multiple-input and multiple-output, MIMO, layers; Tx power; expected SNR and channel conditions);
a set of a plurality of identifiers (e.g. a list of functionality IDs) wherein each identifier identifies:
   a particular FDSS filter design adaptation configuration for a transmission, Tx, FDSS filter design, and
   a particular FDSS filter design adaptation configuration for a receive, Rx, FDSS filter design that is matched with the Tx FDSS filter design; and
one or more extension sizes supported by the UE.

In block 1904, based at least in part on the transmitted first information, the UE receives second information from the gNB, wherein the second information comprises:
configuring information 1905 for configuring the UE to adapt the FDSS filter design, and/or
configuring information 1906 for configuring the UE to adapt the spectral extension parameter.

The second information may comprise adaptation information indicating an adaptation to be applied to the UE's FDSS filter or the spectral extension size to be employed. The adaptation information may be indicated by indicating a functional ID that the UE supports.

The second information may comprise information indicative of one or more of the following:
one or more adaptations of the FDSS filer that the UE is permitted to perform;
at least one rate at which the UE is permitted to adapt the FDSS filter design (e.g. a permissible functionality switching latency);
at least one indication of one or more filter parameters that the UE is permitted to apply to the FDSS filter design to adapt the FDSS filter design;
at least one indication of one or more filter coefficients of the FDSS filter design that the UE is permitted to adapt;
one or more identifiers (e.g. functionality IDs) identifying one or more configuration states that the FDSS filter design is permitted to be adapted to;
one or more identifiers, wherein each identifier identifies a set of parameters (such parameters corresponding to: input(s), output(s), extension Q size, MCS, UE mobility, number of Tx/MIMO layers, SNR channel conditions as mentioned above) that are permitted to be applied to the FDSS filter design to adapt the FDSS filter design, wherein the set of parameters are for at least one of: characterizing, deploying or running the adapted FDSS filter design;
one or more identifiers (e.g. functionality IDs), wherein each identifier identifies:
a particular FDSS filter design adaptation configuration that the FDSS filter design is permitted to be adapted to, and
a particular FDSS filter design adaptation configuration for a receive, Rx, FDSS filter design that is matched with the FDSS filter design; and
one or more adaptations of the spectral extension parameter that the UE is permitted to perform; and/or
a set of one or more extension sizes that the UE is permitted to apply in FDSS-based OFDM transmission with spectral extension.

In block 1907 the UE adapts:
the FDSS filter design, and/or
the spectral extension parameter
   wherein the adaptation is based at least in part on the received second information.

The adaptation of block 1907 comprises, in block 1908, determining an adaptation to apply to the FDSS filter and/or the spectral extension parameter, wherein the determination is based at least in part on the received second information.

The determined adaptation comprises an adaptation of at least one of:
at least one of the plurality of filter coefficients 1909 of the FDSS filter,
at least one of the one or more filter parameters 1910, or
the spectral extension parameter 1911.

The determination may be based at least in part on a channel condition determined by the UE.

The UE's determination of the adaptation to be applied may comprises the UE determining at least one of:
at least one of the plurality of filter coefficients of the UE's FDSS filter this is to be used for the FDSS-based OFDM;
a class of the UE's FDSS filter;
at least one of one or more filter parameters for a class of filter of the UE's FDSS filter that is to be used for the FDSS-based OFDM;
a spectral extension parameter that is to be used for the FDSS-based OFDM with spectral extension transmission; or
a channel condition.

The determining the adaptation comprises at least one of:
using a look-up table;
using an algorithm, such as either a machine-learning algorithm or a non-machine-learning algorithm (i.e. a human defined algorithm comprising a series of if/else operations, a traditional algorithm, or conventional algorithm);
receiving, from the second apparatus information indicative of at least one of:
   at least one of the plurality of filter coefficients of the FDSS filter to be used for the FDSS-based OFDM transmission;
   at least one of the one or more filter parameters for the class of filter of the FDSS filter to be used for the FDSS-based OFDM transmission; or
   the spectral extension parameter to be used for the FDSS-based OFDM with spectral extension transmission.

The FDSS filter may be an ML-based FDSS filter, wherein the plurality of filter coefficients of the FDSS filter are indicative of a plurality of weightings of an ML layer of the ML-based FDSS filter.

The FDSS filter may be a class of filter (whose plurality of filter coefficients are determined by one or more filter parameters for the class of filter. For instance, the FDSS filter may be:
a Root-Raised-Cosine, RRC, filter or a Raised-Cosine, RC, filter whose filter coefficients are determined by a roll-off factor or truncation factor; or
a Gaussian filter whose filter coefficients are determined by a standard deviation.

The filter coefficients of the FDSS filter, or the filter parameters for the class of filter of the FDSS filter, may be learnable via an AI/ML model.

In this regard, the UE may determine the filter coefficients based on a selected extension size, a type of filter class (e.g., RRC filters), and a filter parameter (e.g. roll-off factor for RRC filters). In some examples, for ML-based filters, the filter coefficients may be obtained after executing a training procedure. In some examples, the gNB may have previously shared a lookup table with the UE, and the UE selects a filter parameter from such table. The UE may also determine/observe channel conditions and the UE may also change filter coefficients based on the channel conditions.

In block 1912, the UE adapts the FDSS filter and/or the spectral extension parameter in accordance with the determined adaptation.

In block 1913 the UE transmits, to the gNB, one or more FDSS-based OFDM transmissions 1914, wherein such transmission use:
the adapted FDSS filter design, and/or
the adapted spectral extension parameter (in this regard, the OFDM transmissions may be with or without spectral extension 1915 depending on the spectral extension parameter value Q used, e.g. where Q=M no spectral extension would be applied).

The transmission of the one or more FDSS-based OFDM transmissions may comprises at least one of:
the UE using the adapted FDSS filter design in generating a waveform, via a Tx chain comprising the adapted FDSS filter, and/or
the UE using the adapted spectral extension parameter in performing spectral extension of FDSS-based OFDM transmission with spectral extension.

In some examples (not shown in FIG. 9), the gNB estimates/infers, based at least in part on the received transmission of block 1913, the adaptation that the UE has applied to the UE's FDSS filter design, and/or the spectral extension parameter the UE used.

Such estimation of the adaptation applied by the UE to its FDSS filter design may comprise the gNB estimating one or more filter parameters and/or filter coefficients used by the UE for its FDSS filter design used for the FDSS-based OFDM transmission of block 1913.

Responsive to the gNB's estimation of the filter parameters and/or filter coefficients used by the UE, the gNB may adapt:
its own FDSS filter design it uses for FDSS-based OFDM reception, and/or
the spectral extension parameter its uses for FDSS-based OFDM with spectral extension reception.

The gNB may then determine bits encoded in the UE's FDSS-based OFDM transmission using its adapted FDSS filter design and/or its adapted spectral extension parameter.

In some examples (not shown in FIG. 9), the UE may receive, from the gNB, third information, wherein the third information comprises information for indicting the apparatus to further adapt the FDSS filter design and/or the spectral extension parameter. Responsive to receipt of the same, the UE may further adapt the FDSS filter design, or the spectral extension parameter in accordance with the recited information.

The third information may comprises information for indicating:
filter parameters that the UE is to apply to the FDSS filter design to further adapt the FDSS filter design;
filter coefficients of the FDSS filter design that are to be further adapted; and/or that the UE is to revert to a fallback FDSS filter design configuration or a fallback spectral extension parameter (in this regard, the third information may be a functionality interruption/disable functionality message for indicating to the UE that it is to cease adaptation of the FDSS filter and revert to a pre-determined or default/backup fixed adaptation).

Each of the above described signalling diagrams can be considered to illustrate a plurality of methods, in the sense that each signalling diagrams can be considered to illustrate one or more actions, processes or procedures performed by/at a plurality of actors/entities, e.g. UE 110 and gNB 120 (and, in some implementations employing the use of sidelink communications and transmissions, a UE and a further UE). The signalling diagrams can therefore be considered to illustrate a plurality of individual methods performed by each respective individual actor/entity of the plurality of the actors/entities.

The component blocks of the signalling diagrams are functional and the functions, along with the further functions/functionalities described above, can be performed by a single physical entity (such as an apparatus as is described with reference to FIG. 14—embodied in a UE or gNB). The functions described can also be implemented by a computer program (such as is described with reference to FIG. 15—for execution by a processor of a UE or a gNB).

There now follows a discussion of further possible implementation examples of ML-based transceiver chains of a UE and a gNB that are suitable for use with examples of the present disclosure and its various above described aspects.

FIG. 10 schematically illustrates the main blocks for joint (blind) channel and spectral reshaping estimation and equalization.

To recover a signal received at the gNB, it is necessary to account for both channel and spectral shaping impacts. Thus, the gNB may consider an implementation for joint estimation of the channel and spectral shaping impacts. Consequently, the received signal needs to be equalized based on the estimated channel properties and the considered spectral shaping filter at the UE. The gNB may consider a single block to jointly remove the channel and spectral shaping impacts from the received signal.

FIG. 11 schematically illustrates the main blocks for sequential spectral estimation & reshaping and channel estimation & equalization.

In this implementation, the gNB considers sequential estimation and equalization of the spectral shaping filter and channel response. The gNB may consider different orders for estimation (and equalization) of the spectral shaping filter and channel response impacts. For example, FIG. 11 shows a solution wherein the gNB first applies the spectral reshaping procedure and then estimates and equalizes the signal against the channel effects.

The described implementations consider frequency-domain reference signals. Similar UE and gNB implementation embodiments can be considered with time-domain reference signals by interleaving data and pilots after bit-to-symbol mapping block.

In another implementation, the UE may be enabled to select autonomously a spectral extension Q from a set of allowed values S={M, Q1, . . . , QN}, where the set S may be pre-configured by the NW. The selection may be implemented by a machine learning classifier, or by other digital signal processing means.

Different solutions can be used to optimize/select a proper extension size Q. For example, a continuous variable q can be defined to be able to train with a conventional Stochastic Gradient Descent, SGD, technique. The trainable parameter set for the FDSS filter can be defined as θ={β,q}. Note, in a forward pass, a quantization scheme is applied to apply only an allowed extension size (the quantization is defined in a way that a quantized value should be member of set S). However, such quantization is not applied for the backpropagation.

FIG. 12 schematically shows an example of how such a continuous variable can be defined and trained considering the allowed extension sizes. In this example, the extension size can be trained subject to the allowed values S={M, Q1, . . . , QN}, for extension size. In this example, S={90, 96, 108, 116, 128}.

Alternatively, a UE can train a second ML model that outputs a proper/optimized extension size directly. The inputs to such a model can be, at least, a modulation order, a coding rate, a constellation, requirements on ACLR, and a PAPR threshold.

FIG. 13 schematically illustrates an implementation in which a gNB uses information shared by a UE for spectral reshaping. In this implementation, the UE shares filter parameters (e.g., roll-off and truncation factors for the considered RRC filter in Tx) with the gNB, then the gNB applies sequential spectral reshaping and channel estimation and equalization based at least in part on such received information.

Various of the examples and implementations discussed above may enable dynamic selection of a spectral extension parameter Q and filter design W that can be tuned to extrinsic conditions (e.g., SNR) and also intrinsic conditions (e.g., MCS). Advantageously, this may enable the gNB receiver to improve UL performance while simultaneously controlling for low PAPR.

FIG. 14 schematically illustrates a block diagram of an apparatus 10 for performing the methods, processes, procedures and signaling described in the present disclosure and illustrated in FIGS. 1 to 13. In this regard the apparatus can perform the roles of an entity (such as: UE or gNB) in the illustrated and described methods.

The component blocks of FIG. 14 are functional and the functions described can be performed by a single physical entity, not least such as a UE or gNB.

The apparatus comprises a controller 11, which could be provided within a device/entity, not least such as a UE or gNB.

The controller 11 can be embodied by a computing device, not least such as those mentioned above. In some, but not necessarily all examples, the apparatus can be embodied as a chip, chip set, circuitry or module, i.e. for use in any of the foregoing. As used here ‘module’ refers to a unit or apparatus that excludes certain parts/components that would be added by an end manufacturer or a user.

Implementation of the controller 11 can be as controller circuitry. The controller 11 can be implemented in hardware alone, have certain aspects in software including firmware alone or can be a combination of hardware and software (including firmware).

The controller 11 can be implemented using instructions that enable hardware functionality, for example, by using executable instructions of a computer program 14 in a general-purpose or special-purpose processor 12 that can be stored on a computer readable storage medium 13, for example memory, or disk etc, to be executed by such a processor 12.

The processor 12 is configured to read from and write to the memory 13. The processor 12 can also comprise an output interface via which data and/or commands are output by the processor 12 and an input interface via which data and/or commands are input to the processor 12. The apparatus can be coupled to or comprise one or more other components 15 (not least for example: a radio transceiver, sensors, input/output user interface elements and/or other modules/devices/components for inputting and outputting data/commands).

The memory 13 stores instructions such as a computer program 14 comprising such instructions (e.g. computer program instructions/code) that controls the operation of the apparatus 10 when loaded into the processor 12. The instructions of the computer program 14, provide the logic and routines that enables the apparatus to perform the methods, processes and procedures described in the present disclosure and illustrated in FIGS. 1 to 23. The processor 12 by reading the memory 13 is able to load and execute the computer program 14.

The instructions may be comprised in a computer program, a non-transitory computer readable medium, a computer program product, a machine readable medium. The term “non-transitory,” as used herein, is a limitation of the medium itself (i.e. tangible, not a signal) as opposed to a limitation on data storage persistency (e.g. RAM vs. ROM). In some but not necessarily all examples, the computer program instructions may be distributed over more than one computer program.

Although the memory 13 is illustrated as a single component/circuitry it can be implemented as one or more separate components/circuitry some or all of which can be integrated/removable and/or can provide permanent/semi-permanent/dynamic/cached storage.

Although the processor 12 is illustrated as a single component/circuitry it can be implemented as one or more separate components/circuitry some or all of which can be integrated/removable. The processor 12 can be a single core or multi-core processor.

The apparatus can include one or more components for effecting the methods, processes and procedures described in the present disclosure and illustrated in FIGS. 1 to 23. It is contemplated that the functions of these components can be combined in one or more components or performed by other components of equivalent functionality. The description of a function should additionally be considered to also disclose any means suitable for performing that function.

Where a structural feature has been described, it can be replaced by means for performing one or more of the functions of the structural feature whether that function or those functions are explicitly or implicitly described.

Although examples of the apparatus have been described above in terms of comprising various components, it should be understood that the components can be embodied as or otherwise controlled by a corresponding controller or circuitry such as one or more processing elements or processors of the apparatus. In this regard, each of the components described above can be one or more of any device, means or circuitry embodied in hardware, software or a combination of hardware and software that is configured to perform the corresponding functions of the respective components as described above.

The apparatus can, for example, be: a user equipment, base station or network node of a mobile cellular telecommunication system. The apparatus can be embodied by a computing device, not least such as those mentioned above. However, in some examples, the apparatus can be embodied as a chip, chip set, circuitry or module, i.e. for use in any of the foregoing.

In one example, the apparatus is embodied on a client device, a UE, a mobile cellular telephone, a hand held portable electronic device, a mobile communication device, a wearable computing device or a personal digital assistant, that can additionally provide one or more audio/text/video communication functions (for example telecommunication, video-communication, and/or text transmission (Short Message Service (SMS)/Multimedia Message Service (MMS)/emailing) functions), interactive/non-interactive viewing functions (for example web-browsing, navigation, TV/program viewing functions), music recording/playing functions (for example Moving Picture Experts Group-1 Audio Layer 3 (MP3) or other format and/or (frequency modulation/amplitude modulation) radio broadcast recording/playing), downloading/sending of data functions, image capture function (for example using a (for example in-built) digital camera), and gaming functions, or any combination thereof.

In some examples (such as wherein the apparatus is provided within a UE 110), the apparatus 10 comprises:
at least one processor 12; and
at least one memory 13 storing instructions that, when executed by the at least one processor 12, cause the apparatus at least to:
transmit, to a second apparatus, first information indicative of a capability of the apparatus to adapt at least one of:
   a frequency-domain spectral shaping, FDSS, filter for FDSS-based orthogonal frequency division multiplexing, OFDM, transmission, or
   a spectral extension parameter for use in FDSS-based OFDM with spectral extension transmission;
receive, from the second apparatus based at least in part on the transmitted first information, second information, wherein the second information comprises information for configuring the apparatus to adapt at least one of the FDSS filter or the spectral extension parameter;
determine an adaptation to apply to at least one of the FDSS filter or the spectral extension parameter, wherein the determination is based at least in part on the received second information, and wherein the adaptation comprises adapting at least one of:
   at least one of a plurality of filter coefficients of the FDSS filter,
   at least one of one or more filter parameters, or
   the spectral extension parameter; and
transmit, to the second apparatus, at least one FDSS-based OFDM transmission, wherein the transmitting uses at least one of:
   the FDSS filter with the determined adaptation applied thereto, or
   the spectral extension parameter with the determined adaptation applied thereto.

The above described examples find application as enabling components of: telecommunication systems; tracking systems, automotive systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things (IOT); Vehicle-to-everything (V2X), virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

FIG. 15, illustrates a computer program 14 which may be conveyed via a delivery mechanism 20. The delivery mechanism 20 can be any suitable delivery mechanism, for example, a machine readable medium, a computer-readable medium, a non-transitory computer-readable storage medium, a computer program product, a memory device, a solid-state memory, a record medium such as a Compact Disc Read-Only Memory (CD-ROM) or a Digital Versatile Disc (DVD) or an article of manufacture that comprises or tangibly embodies the computer program 14. The delivery mechanism can be a signal configured to reliably transfer the computer program. An apparatus can receive, propagate or transmit the computer program as a computer data signal.

In certain examples of the present disclosure, there is provided a computer program comprising instructions, which when executed by an apparatus (e.g. UE 110), cause the apparatus to perform at least the following or for causing performing at least the following:
transmitting, to a second apparatus, first information indicative of a capability of the apparatus to adapt at least one of:
   a frequency-domain spectral shaping, FDSS, filter for FDSS-based orthogonal frequency division multiplexing, OFDM, transmission, or
   a spectral extension parameter for use in FDSS-based OFDM with spectral extension transmission;
receiving, from the second apparatus based at least in part on the transmitted first information, second information, wherein the second information comprises information for configuring the apparatus to adapt at least one of the FDSS filter or the spectral extension parameter;
determining an adaptation to apply to at least one of the FDSS filter or the spectral extension parameter, wherein the determination is based at least in part on the received second information, and wherein the adaptation comprises adapting at least one of:
   at least one of a plurality of filter coefficients of the FDSS filter,
   at least one of one or more filter parameters, or
   the spectral extension parameter; and
transmitting, to the second apparatus, at least one FDSS-based OFDM transmission, wherein the transmitting uses at least one of:
   the FDSS filter with the determined adaptation applied thereto, or
   the spectral extension parameter with the determined adaptation applied thereto.

References to ‘computer program’, ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ can refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to a particular claim element, a baseband integrated circuit for a mobile device or a similar integrated circuit in a server, a cellular network device, or other computing or network device.

Although various examples of the present disclosure have been described in the preceding paragraphs, it should be appreciated that modifications to the examples given can be made without departing from the scope of the invention as set out in the claims.

The blocks illustrated in FIGS. 2 to 23 can represent actions in a method, functionality performed by an apparatus, and/or sections of instructions/code in a computer program.

It will be understood that each block and combinations of blocks illustrated in FIGS. 2 to 23 as well as the further functionality described above, can be implemented by various means, such as hardware, firmware, and/or software including one or more computer program instructions. For example, one or more of the functions described above can be performed by a duly configured apparatus (such as an apparatus [as shown in FIG. 8] comprising means for performing the above described functionality). One or more of the functions/functionality described above can be embodied by a duly configured computer program (such as a computer program [as shown in FIG. 9] comprising computer program instructions which embody the functions/functionality described above and which can be stored by a memory storage device and performed by a processor).

As will be appreciated, any such computer program instructions can be loaded onto a computer or other programmable apparatus (i.e. hardware) to produce a machine, such that the instructions when performed on the programmable apparatus create means for implementing the functions/functionality specified in the blocks. These computer program instructions can also be stored in a computer-readable medium that can direct a programmable apparatus to function in a particular manner, such that the instructions stored in the computer-readable memory produce an article of manufacture including instruction means which implement the function specified in the blocks. The computer program instructions can also be loaded onto a programmable apparatus to cause a series of operational actions to be performed on the programmable apparatus to produce a computer-implemented process such that the instructions which are performed on the programmable apparatus provide actions for implementing the functions/functionality specified in the blocks.

Various, but not necessarily all, examples of the present disclosure can take the form of a method, an apparatus, or a computer program. Accordingly, various, but not necessarily all, examples can be implemented in hardware, software or a combination of hardware and software.

Various, but not necessarily all, examples of the present disclosure are described using flowchart illustrations and schematic block diagrams. It will be understood that each block (of the flowchart illustrations and block diagrams), and combinations of blocks, can be implemented by computer program instructions of a computer program. These program instructions can be provided to one or more processor(s), processing circuitry or controller(s) such that the instructions which execute on the same create means for causing implementing the functions specified in the block or blocks, i.e. such that the method can be computer implemented. The computer program instructions can be executed by the processor(s) to cause a series of operational block/steps/actions to be performed by the processor(s) to produce a computer implemented process such that the instructions which execute on the processor(s) provide block/steps for implementing the functions specified in the block or blocks.

Accordingly, the blocks support: combinations of means for performing the specified functions; combinations of actions for performing the specified functions; and computer program instructions/algorithm for performing the specified functions. It will also be understood that each block, and combinations of blocks, can be implemented by special purpose hardware-based systems which perform the specified functions or actions, or combinations of special purpose hardware and computer program instructions.

Various, but not necessarily all, examples of the present disclosure provide both a method and corresponding apparatus comprising various modules, means or circuitry that provide the functionality for performing/applying the actions of the method. The modules, means or circuitry can be implemented as hardware, or can be implemented as software or firmware to be performed by a computer processor. In the case of firmware or software, examples of the present disclosure can be provided as a computer program product including a computer readable storage structure embodying computer program instructions (i.e. the software or firmware) thereon for performing by the computer processor.

Although specific terms are employed herein, they are used in a generic and descriptive sense only and not for purposes of limitation.

Features described in the preceding description can be used in combinations other than the combinations explicitly described.

Although functions have been described with reference to certain features, those functions can be performable by other features whether described or not.

Although features have been described with reference to certain examples, those features can also be present in other examples whether described or not. Accordingly, features described in relation to one example/aspect of the disclosure can include any or all of the features described in relation to another example/aspect of the disclosure, and vice versa, to the extent that they are not mutually inconsistent. For instance, it will be understood that the above described aspect could be combined, e.g. a UE/gNB may be configured to employ one or more of the: inference, data collection, training and monitoring operational modes.

The term ‘comprise’ is used in this document with an inclusive not an exclusive meaning. That is any reference to X comprising Y indicates that X can comprise only one Y or can comprise more than one Y. If it is intended to use ‘comprise’ with an exclusive meaning then it will be made clear in the context by referring to “comprising only one . . . ” or by using “consisting”.

In this description, the wording ‘connect’ and ‘communication’ and their derivatives mean operationally connected/in communication. It should be appreciated that any number or combination of intervening components can exist (including no intervening components), i.e. so as to provide direct or indirect connection/coupling/communication. Any such intervening components can include hardware and/or software components.

As used herein, the term “determine/determining” (and grammatical variants thereof) can include, not least: evaluating, calculating, computing, processing, deriving, measuring, investigating, identifying, looking up (for example, looking up in a table, a database or another data structure), ascertaining and the like. Also, “determining” can include receiving (for example, receiving information), retrieving/accessing (for example, retrieving/accessing data in a memory), obtaining and the like. Also, “determine/determining” can include resolving, selecting, choosing, establishing, inferring and the like.

As used herein, a description of an action should also be considered to disclose enabling, and/or causing, and/or controlling that action. For example, a description of transmitting information should also be considered to disclose enabling, and/or causing, and/or controlling transmitting information. Similarly, for example, a description of an apparatus transmitting information should also be considered to disclose at least one means or controller of the apparatus enabling, and/or causing, and/or controlling the apparatus to transmit the information.”

The term “means” as used in the description and in the claims may refer to one or more individual elements configured to perform the corresponding recited functionality or functionalities, or it may refer to several elements that perform such functionality or functionalities. Furthermore, several functionalities recited in the claims may be performed by the same individual means or the same combination of means. For example performing such functionality or functionalities may be caused in an apparatus by a processor that executes instructions stored in a memory of the apparatus.

References to a parameter, or value of a parameter, should be understood to refer to “data indicative of”, “data defining” or “data representative of” the relevant parameter/parameter value if not explicitly stated (unless the context demands otherwise). The data may be in any way indicative of the relevant parameter/parameter value, and may be directly or indirectly indicative thereof.

In this description, reference has been made to various examples. The description of features or functions in relation to an example indicates that those features or functions are present in that example. The use of the term ‘example’ or ‘for example’, ‘can’ or ‘may’ in the text denotes, whether explicitly stated or not, that such features or functions are present in at least the described example, whether described as an example or not, and that they can be, but are not necessarily, present in some or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class.

In this description, references to “a/an/the” [feature, element, component, means . . . ] are used with an inclusive not an exclusive meaning and are to be interpreted as “at least one” [feature, element, component, means . . . ] unless explicitly stated otherwise. That is any reference to X comprising a/the Y indicates that X can comprise only one Y or can comprise more than one Y unless the context clearly indicates the contrary. If it is intended to use ‘a’ or ‘the’ with an exclusive meaning then it will be made clear in the context. In some circumstances the use of ‘at least one’ or ‘one or more’ can be used to emphasise an inclusive meaning but the absence of these terms should not be taken to infer any exclusive meaning. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The presence of a feature (or combination of features) in a claim is a reference to that feature (or combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

In the above description, the apparatus described can alternatively or in addition comprise an apparatus which in some other examples comprises a distributed system of apparatus, for example, a client/server apparatus system. In examples where an apparatus provided forms (or a method is implemented as) a distributed system, each apparatus forming a component and/or part of the system provides (or implements) one or more features which collectively implement an example of the present disclosure. In some examples, an apparatus is re-configured by an entity other than its initial manufacturer to implement an example of the present disclosure by being provided with additional software, for example by a user downloading such software, which when executed causes the apparatus to implement an example of the present disclosure (such implementation being either entirely by the apparatus or as part of a system of apparatus as mentioned hereinabove).

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavouring in the foregoing specification to draw attention to those features of examples of the present disclosure believed to be of particular importance it should be understood that the applicant claims protection in respect of any patentable feature or combination of features hereinbefore referred to and/or shown in the drawings whether or not particular emphasis has been placed thereon.

The examples of the present disclosure and the accompanying claims can be suitably combined in any manner apparent to one of ordinary skill in the art. Separate references to an “example”, “in some examples” and/or the like in the description do not necessarily refer to the same example and are also not mutually exclusive unless so stated and/or except as will be readily apparent to those skilled in the art from the description. For instance, a feature, structure, process, block, step, action, or the like described in one example may also be included in other examples, but is not necessarily included.

Each and every claim is incorporated as further disclosure into the specification and the claims are embodiment(s) of the present disclosure. Further, while the claims herein are provided as comprising specific dependencies, it is contemplated that any claims can depend from any other claims and that to the extent that any alternative embodiments can result from combining, integrating, and/or omitting features of the various claims and/or changing dependencies of claims, any such alternative embodiments and their equivalents are also within the scope of the disclosure.

1. An apparatus comprising:
at least one processor; and
at least one memory storing instructions that, when executed by the at least one processor, cause the apparatus at least to:
transmit, to a second apparatus, first information indicative of a capability of the apparatus to adapt at least one of:
a frequency-domain spectral shaping, FDSS, filter for FDSS-based orthogonal frequency division multiplexing, OFDM, transmission, or
a spectral extension parameter for use in FDSS-based OFDM with spectral extension transmission;
receive, from the second apparatus based at least in part on the transmitted first information, second information, wherein the second information comprises information for configuring the apparatus to adapt at least one of the FDSS filter or the spectral extension parameter;
determine an adaptation to apply to at least one of the FDSS filter or the spectral extension parameter, wherein the determination is based at least in part on the received second information, and wherein the adaptation comprises adapting at least one of:
at least one of a plurality of filter coefficients of the FDSS filter,
at least one of one or more filter parameters, or
the spectral extension parameter; and
transmit, to the second apparatus, at least one FDSS-based OFDM transmission, wherein the transmitting uses at least one of:
the FDSS filter with the determined adaptation applied thereto, or
the spectral extension parameter with the determined adaptation applied thereto.

2. The apparatus of claim 1, wherein the determination is based at least in part on a channel condition.

3. The apparatus of claim 1, wherein determining the adaptation comprises determining at least one of:
at least one of the plurality of filter coefficients of the FDSS filter to be used for the FDSS-based OFDM transmission;
a class of the FDSS filter;
at least one of one or more filter parameters for a class of filter of the FDSS filter to be used for the FDSS-based OFDM transmission;
the spectral extension parameter to be used for the FDSS-based OFDM with spectral extension transmission; or
a channel condition.

4. The apparatus of claim 1, wherein determining the adaptation comprises at least one of:
using a look-up table;
using an algorithm;
receiving, from the second apparatus information indicative of at least one of:
at least one of the plurality of filter coefficients of the FDSS filter to be used for the FDSS-based OFDM transmission;
at least one of the one or more filter parameters for the class of filter of the FDSS filter to be used for the FDSS-based OFDM transmission; or
the spectral extension parameter to be used for the FDSS-based OFDM with spectral extension transmission.

5. The apparatus of claim 1, wherein the FDSS filter is a machine learning, ML, based FDSS filter, and wherein the plurality of filter coefficients of the FDSS filter are indicative of a plurality of weightings of an ML layer of the ML-based FDSS filter.

6. The apparatus of claim 1, wherein the FDSS filter is a class of filter whose plurality of filter coefficients are determined by one or more filter parameters for the class of filter.

7. The apparatus of claim 6, wherein the class of filter comprises at least one of the following:
a Root-Raised-Cosine, RRC, filter;
a Raised-Cosine, RC, filter; or
a Gaussian filter.

8. The apparatus of claim 6, wherein the one or more filter parameters for the class of filter comprises at least one of the following:
a roll-off factor;
a truncation factor; or
a standard deviation.

9. The apparatus of claim 1, wherein at least one of:
the plurality of filter coefficients of the FDSS filter, or
the one or more filter parameters for the class of filter of the FDSS filter are learnable via a machine learning, ML, model.

10. The apparatus of claim 1, wherein the FDSS filter is at least one of the following:
a Tx filter matched with a corresponding receive, Rx, filter of the second apparatus;
an adaptable filter of a transmission, Tx, chain;
configurable filter whose configured state is defined by a plurality of filter coefficients;
a configurable filter whose filter coefficients are determined based at least in part on one or more filter parameters;
a machine learning, ML, based filter; or
a configurable filter whose operation is determined by one or more filter parameters.

11. The apparatus of claim 1, wherein the first information comprises information indicative of one or more of the following:
a capability of the apparatus to perform FDSS-based OFDM transmission;
a capability of the apparatus to perform FDSS-based OFDM transmission with spectral extension;
a parameter indicative of a rate at which the FDSS filter can be adapted;
at least one indication of one or more filter parameters that the apparatus is capable of applying to the FDSS filter to adapt the FDSS filter;
at least one indication of one or more filter coefficients of the FDSS filter that the apparatus is capable of adapting;
one or more identifiers for identifying one or more configuration states that the FDSS filter is able to be adapted to;
one or more identifiers, wherein each identifier identifies a set of parameters for at least one of: characterizing, deploying or running an adapted FDSS filter; or
a set of a plurality of identifiers wherein each identifier identifies:
a particular FDSS filter adaptation configuration for a transmission, Tx, FDSS filter, and
a particular FDSS filter adaptation configuration for a receive, Rx, FDSS filter that is matched with the Tx FDSS filter.

12. The apparatus of claim 1, wherein the first information comprises information indicative of:
one or more spectral extension sizes supported by the apparatus.

13. The apparatus of claim 1, wherein the second information comprises information indicative of one or more of the following:
one or more adaptations of the FDSS filer that the apparatus is permitted to perform;
at least one parameter indicative of at least one rate at which the apparatus is permitted to adapt the FDSS filter;
at least one indication of one or more filter parameters that the apparatus is permitted to apply to the FDSS filter to adapt the FDSS filter;
at least one indication of one or more filter coefficients of the FDSS filter that the apparatus is permitted to adapt;
one or more identifiers identifying one or more configuration states that the FDSS filter is permitted to be adapted to;
one or more identifiers, wherein each identifier identifies a set of filter parameters that are permitted to be applied to the FDSS filter to adapt the FDSS filter, wherein the set of filter parameters are for at least one of: characterizing, deploying or running the adapted FDSS filter;
one or more identifiers, wherein each identifier identifies:
a particular FDSS filter adaptation configuration that the FDSS filter is permitted to be adapted to, and
a particular FDSS filter adaptation configuration for a receive, Rx, FDSS filter that is matched with the FDSS filter.

14. The apparatus of claim 1, wherein the second information comprises information indicative of one or more of the following:
one or more adaptations of a spectral extension parameter that the apparatus is permitted to perform; or
at least one extension size the apparatus is permitted to apply in FDSS-based OFDM transmission with spectral extension.

15. The apparatus of claim 1, wherein the transmitting of the at least one FDSS-based OFDM transmission comprises at least one of:
using the adapted FDSS filter in generating a waveform for FDSS-based OFDM transmission, or
using the adapted spectral extension parameter in performing spectral extension of FDSS-based OFDM transmission with spectral extension.

16. The apparatus of claim 1, wherein the apparatus is further caused to:
receive, from the second apparatus, third information, wherein the third information comprises information for indicting the apparatus to further adapt the FDSS filter; and
further adapt the FDSS filter, wherein the further adaptation is based at least in part on the third information.

17. The apparatus of claim 16, wherein the third information comprises information for indicating at least one of the following:
an indication of one or more filter parameters that the apparatus is to apply to the FDSS filter to further adapt the FDSS filter;
an indication of one or more filter coefficients of the FDSS filter that are to be further adapted;
that the apparatus is to revert to a fallback FDSS filter configuration or a fallback spectral extension parameter.

18. The apparatus of claim 1, wherein the FDSS-based OFDM transmission comprises at least one of:
an FDSS-based discrete Fourier transform spread orthogonal frequency division multiplexing, DFT-s-OFDM, transmission; or
FDSS-based Cyclic Prefix, CP, OFDM transmission.

19. A method comprising:
transmitting, from an apparatus to a second apparatus, first information indicative of a capability of the apparatus to adapt at least one of:
a frequency-domain spectral shaping, FDSS, filter for FDSS-based orthogonal frequency division multiplexing, OFDM, transmission, or
a spectral extension parameter for use in FDSS-based OFDM with spectral extension transmission;
receiving, at the apparatus from the second apparatus based at least in part on the transmitted first information, second information, wherein the second information comprises information for configuring the apparatus to adapt at least one of the FDSS filter or the spectral extension parameter;
determining, at the apparatus, an adaptation to apply to at least one of the FDSS filter or the spectral extension parameter, wherein the determination is based at least in part on the received second information, and wherein the adaptation comprises adapting at least one of:
at least one of a plurality of filter coefficients of the FDSS filter,
at least one of one or more filter parameters, or
the spectral extension parameter; and
transmitting, from the apparatus to the second apparatus, at least one FDSS-based OFDM transmission, wherein the transmitting uses at least one of:
the FDSS filter with the determined adaptation applied thereto, or
the spectral extension parameter with the determined adaptation applied thereto.

20. A non-transitory computer readable medium comprising instructions which, when executed by an apparatus, cause the apparatus to perform:
transmitting, to a second apparatus, first information indicative of a capability of the apparatus to adapt at least one of:
a frequency-domain spectral shaping, FDSS, filter for FDSS-based orthogonal frequency division multiplexing, OFDM, transmission, or
a spectral extension parameter for use in FDSS-based OFDM with spectral extension transmission;
receiving, from the second apparatus based at least in part on the transmitted first information, second information, wherein the second information comprises information for configuring the apparatus to adapt at least one of the FDSS filter or the spectral extension parameter;
determining an adaptation to apply to at least one of the FDSS filter or the spectral extension parameter, wherein the determination is based at least in part on the received second information, and wherein the adaptation comprises adapting at least one of:
at least one of a plurality of filter coefficients of the FDSS filter,
at least one of one or more filter parameters, or
the spectral extension parameter; and
transmitting, to the second apparatus, at least one FDSS-based OFDM transmission, wherein the transmitting uses at least one of:
the FDSS filter with the determined adaptation applied thereto, or
the spectral extension parameter with the determined adaptation applied thereto.
